(19) United States
(12) Patent Application Publication
(10) Pub. No.: US 2024/0406914 A1
(43) Pub. Date: Dec. 5, 2024

(54) POSITIONING METHOD AND DEVICE THEREFOR

(71) Applicant: LG ELECTRONICS INC., Seoul (KR)

(72) Inventors: Jeongsu LEE, Seoul (KR); Hyunsoo KO, Seoul (KR); Haewook PARK, Seoul (KR); Kijun KIM, Seoul (KR)

(73) Assignee: LG ELECTRONICS INC., Seoul (KR)

(21) Appl. No.: 18/695,764

(22) PCT Filed: Sep. 30, 2022
(86) PCT No.: PCT/KR2022/014839

§ 371 Date: Mar. 26, 2024

(30) Foreign Application Priority Data
Sep. 30, 2021 (KR) 10-2021-0130387

(51) Int. Cl. H04W 64/00; H04L 1/1607; H04L 5/00; H04W 24/10

(52) U.S. Cl. CPC H04W 64/00; H04L 1/1642; H04L 5/0051; H04W 24/10

(57) ABSTRACT

In an embodiment of the present specification, a method for performing positioning by a terminal in a wireless communication system comprises the steps of: receiving, from a position server, a request message for requesting measurement for the positioning, wherein the request message includes information for configuration of a measurement time window related to measurement for the positioning; and performing measurement for the positioning, on the basis of the request message, wherein the measurement for the positioning is performed on the basis of the measurement time window configured on the basis of the information for configuration of the measurement time window, and the measurement time window is configured on the basis of (i) a system frame number (SFN) and/or a slot number or (ii) a time point at which the terminal has received the request message.

### CROSS-REFERENCE TO RELATED APPLICATION(S)

This application is the National Stage filing under 35 U.S.C. 371 of International Application No. PCT/KR2022/014839, filed on Sep. 30, 2022, which claims the benefit of earlier filing date and right of priority to Korean Application No. 10-2021-0130387, filed on Sep. 30, 2021, the contents of which are all incorporated by reference herein in their entirety.

### TECHNICAL FIELD

The present disclosure relates to a positioning method in a wireless communication system and device therefor.

### BACKGROUND

Mobile communication systems have been developed to guarantee user activity while providing voice services. Mobile communication systems are expanding their services from voice only to data. Current soaring data traffic is depleting resources and users' demand for higher-data rate services is leading to the need for more advanced mobile communication systems.

Next-generation mobile communication systems are required to meet, e.g., handling of explosively increasing data traffic, significant increase in per-user transmission rate, working with a great number of connecting devices, and support for very low end-to-end latency and high-energy efficiency. To that end, various research efforts are underway for various technologies, such as dual connectivity, massive multiple input multiple output (MIMO), in-band full duplex, non-orthogonal multiple access (NOMA), super wideband support, and device networking.

Meanwhile, in relation to positioning, a location server (e.g. Location Management Function, LMF) may transmit information for a search window (expected RSTD and uncertainty) to a base station (TRP)/a user equipment (UE) for efficient measurement of timing related positioning. However, this information (i.e. search window) cannot be helpful for angle-based measurement.

In relation to the angle-based measurement, the location server configures PRS resources in the UE. At this time, the location server delivers QCL information for the Rx beam to the UE. The UE receives the PRS through the indicated/configured Rx beam, but this may not be an optimal beam that perfectly reflects the location of the TRP.

### SUMMARY

The purpose of the present disclosure is to provide a positioning method in a wireless communication system and a device for the same.

In addition, the purpose of the present disclosure is to provide a method for configuring a measurement window to synchronize a measurement performance timing for positioning of a user equipment (UE) and a base station in a wireless communication system from a time perspective and a device for the same.

In addition, the purpose of the present disclosure is to provide a method for performing a measurement for positioning in consideration of measurement gap configuration and measurement window configuration for measuring positioning reference signal resources in a wireless communication system and a device for the same.

The technical objects of the present disclosure are not limited to the aforementioned technical objects, and other technical objects, which are not mentioned above, will be apparently appreciated by a person having ordinary skill in the art from the following description.

A method of a user equipment (UE) to perform positioning in a wireless communication system according to an embodiment of the present disclosure, the method comprises receiving, from a location server, a request message requesting measurement for the positioning, wherein the request message includes information for configuration of a measurement time window related to the measurement for the positioning, and performing the measurement for the positioning based on the request message, wherein the measurement for the positioning is performed based on the measurement time window that is configured based on the information for configuration of the measurement time window, and wherein the measurement time window is configured based on (i) a system frame number (SFN) and/or a slot number or (ii) a time point in which the UE receives the request message.

Additionally, in the present disclosure, the measurement time window may be configured based on the system frame number and/or the slot number.

Additionally, in the present disclosure, the measurement time window may be configured based on (i) an offset related to a time point in which the measurement time window is started from the system frame number and/or the slot number, (ii) a cycle in which the measurement time window is configured, and (iii) a duration of the measurement time window.

Additionally, in the present disclosure, one radio frame in which the measurement time window is configured may include at least one measurement time window instance.

Additionally, in the present disclosure, a number of the at least one measurement time window instance included in the one radio frame may be configured based on a number of repetitions, and a time gap may be configured between the at least one measurement time window instance included in the one radio frame.

Additionally, in the present disclosure, the information for configuration of the measurement time window may include (i) information for the offset related to the time point in which the measurement time window is started from the system frame number and/or the slot number, (ii) information for the cycle in which the measurement time window is configured, (iii) information for the duration of the measurement time window, (iv) information for the number of repetitions, and (v) information for the time gap configured between the at least one measurement time window instance.

Additionally, in the present disclosure, the information for the offset may be applied based on both the system frame number and the slot number.

Additionally, in the present disclosure, the information for the offset may include first offset information applied based on the system frame number and second offset information applied based on the slot number.

Additionally, in the present disclosure, the measurement time window may be configured based on information in bitmap form for a slot in which the measurement time window exists among at least one slot included in a radio frame in which the measurement time window is configured among all radio frames, and the information for configuration of the measurement time window may include information for a cycle in which the radio frame for which the measurement time window is configured is configured.

Additionally, in the present disclosure, the measurement time window may be configured based on the time in which the UE receives the request message.

Additionally, in the present disclosure, the measurement time window may start based on (i) a time point in which the UE starts receiving the request message or (ii) a time point in which the UE ends receiving the request message and may last for a certain period of time.

Additionally, in the present disclosure, the request message may include information for the certain period of time for which the measurement time window lasts.

Additionally, in the present disclosure, the request message may further include information for an offset from (i) a time point in which the UE starts receiving the request message or (ii) a time point in which the UE ends receiving the request message to a time point in which the measurement time window is started.

Additionally, in the present disclosure, the measurement for the positioning may be performed further based on a measurement gap related to a measurement for a positioning reference signal (PRS) resource, may further comprise transmitting information for a result of the measurement for the positioning, and the information for the result of the measurement for the positioning may include information for whether the measurement for the positioning is performed within the measurement time window.

Additionally, in the present disclosure, the measurement for the positioning may be performed further based on a time threshold related to whether or not to perform the measurement for the positioning within the measurement time window, wherein based on the measurement time window being configured within the time threshold from the time in which the UE receives the request message, the measurement for the positioning may be performed within the measurement time window, and wherein based on the measurement time window being not configured within the time threshold from the time in which the UE receives the request message, the measurement for the positioning may be performed in a positioning reference signal (PRS) resource regardless of the measurement time window.

Additionally, in the present disclosure, a user equipment (UE) performing positioning in a wireless communication system, the UE comprises one or more transceivers; one or more processors controlling the one or more transceivers; and one or more memories operably connected to the one or more processors, wherein the one or more memories store instructions for performing operations based on being executed by the one or more processors, wherein the operations include receiving, from a location server, a request message requesting measurement for the positioning, wherein the request message includes information for configuration of a measurement time window related to the measurement for the positioning; and performing the measurement for the positioning based on the request message, wherein the measurement for the positioning is performed based on the measurement time window that is configured based on the information for configuration of the measurement time window, and wherein the measurement time window is configured based on (i) a system frame number (SFN) and/or a slot number or (ii) a time point in which the UE receives the request message.

Additionally, in the present disclosure, a device for controlling a user equipment (UE) to perform positioning in a wireless communication system, the device comprises one or more processors; and one or more memories operably connected to the one or more processors, wherein the one or more memories store instructions for performing operations based on being executed by the one or more processors, wherein the operations include receiving, from a location server, a request message requesting measurement for the positioning, wherein the request message includes information for configuration of a measurement time window related to the measurement for the positioning; and performing the measurement for the positioning based on the request message, wherein the measurement for the positioning is performed based on the measurement time window that is configured based on the information for configuration of the measurement time window, and wherein the measurement time window is configured based on (i) a system frame number (SFN) and/or a slot number or (ii) a time point in which the UE receives the request message.

Additionally, in the present disclosure, one or more non-transitory computer-readable medium storing one or more instructions, wherein the one or more instructions perform operations based on being executed by one or more processors, wherein the operations include receiving, from a location server, a request message requesting measurement for the positioning, wherein the request message includes information for configuration of a measurement time window related to the measurement for the positioning; and performing the measurement for the positioning based on the request message, wherein the measurement for the positioning is performed based on the measurement time window that is configured based on the information for configuration of the measurement time window, and wherein the measurement time window is configured based on (i) a system frame number (SFN) and/or a slot number or (ii) a time point in which the UE receives the request message.

Additionally, in the present disclosure, a method of a location server to perform positioning in a wireless communication system, the method comprises transmitting, to a user equipment (UE), a request message requesting measurement for the positioning, wherein the request message includes information for configuration of a measurement time window related to the measurement for the positioning; and performing the measurement for the positioning based on the request message, wherein the measurement for the positioning is performed based on the measurement time window that is configured based on the information for configuration of the measurement time window, and wherein the measurement time window is configured based on (i) a system frame number (SFN) and/or a slot number or (ii) a time point in which the UE receives the request message.

Additionally, in the present disclosure, a location server receiving information for a measurement of a positioning reference signal (PRS) in a wireless communication, the location server comprises one or more transceivers: one or more processors controlling the one or more transceivers; and one or more memories operably connected to the one or more processors, wherein the one or more memories store instructions for performing operations based on being executed by the one or more processors, wherein the operations include transmitting, to a user equipment (UE), a request message requesting measurement for the positioning, wherein the request message includes information for configuration of a measurement time window related to the measurement for the positioning; and performing the measurement for the positioning based on the request message, wherein the measurement for the positioning is performed based on the measurement time window that is configured based on the information for configuration of the measurement time window, and wherein the measurement time window is configured based on (i) a system frame number (SFN) and/or a slot number or (ii) a time point in which the UE receives the request message.

The present disclosure has the effect of performing positioning in a wireless communication system.

In addition, the present disclosure has an effect of increasing the efficiency of utilizing measurement results in the location server by configuring a measurement time window that synchronizes the measurement performance timing for positioning of the UE and base station in a wireless communication system from a time perspective.

In addition, the present disclosure has an effect of performing positioning considering both the importance of accuracy of measurement results when positioning and the importance of utilizing measurement results with low latency by performing measurements for positioning considering the measurement gap configuration and measurement window configuration for measuring positioning reference signal resources in a wireless communication system.

Effects which may be obtained by the present disclosure are not limited to the aforementioned effects, and other technical effects not described above may be evidently understood by a person having ordinary skill in the art to which the present disclosure pertains from the following description.

### BRIEF DESCRIPTION OF THE DRAWINGS

The accompanying drawings, which are included to provide a further understanding of the present disclosure and constitute a part of the detailed description, illustrate embodiments of the present disclosure and together with the description serve to explain the principle of the present disclosure.

FIG. 1 is a diagram illustrating an example of an overall system structure of NR to which a method proposed in the present disclosure is applicable.

FIG. 2 illustrates a relationship between an uplink frame and a downlink frame in a wireless communication system to which a method proposed by the present disclosure is applicable.

FIG. 3 illustrates an example of a frame structure in an NR system.

FIG. 4 illustrates an example of a resource grid supported by a wireless communication system to which a method proposed in the present disclosure is applicable.

FIG. 5 illustrates examples of a resource grid for each antenna port and numerology to which a method proposed in the present disclosure is applicable.

FIG. 6 illustrates physical channels and general signal transmission used in a 3GPP system.

FIG. 7 is a diagram illustrating an example of a positioning protocol configuration for measuring a location of a user equipment (UE).

FIG. 8 is a diagram illustrating an example of architecture of a system for measuring a location of an UE.

FIG. 9 is a diagram illustrating an example of a procedure for measuring a location of a UE.

FIG. 10 is a diagram illustrating an example of a protocol layer for supporting LPP message transmission.

FIG. 11 is a diagram illustrating an example of a protocol layer for supporting NRPPa transmission.

FIG. 12 is a diagram illustrating an example of an OTDOA positioning measurement method.

FIGS. 13A and 13B are diagrams illustrating an example of a Multi RTT positioning measurement method.

FIG. 14 is a diagram briefly illustrating a method of operating a UE, TRP, location server, and/or LMF according to various embodiments of the present disclosure.

FIG. 15 is a diagram briefly illustrating a method of operating a UE, TRP, location server, and/or LMF according to various embodiments of the present disclosure.

FIG. 16 is a diagram showing an example of measurement time window configuration.

FIG. 17 is a diagram showing examples of measurement window configuration related to measurement for positioning of a UE/base station.

FIG. 18 is a diagram showing an example of measurement window configuration.

FIG. 19 is a diagram showing another example of measurement window configuration.

FIG. 20 is a flowchart showing an example in which a method proposed in the present disclosure is performed by a UE.

FIG. 21 is a flowchart showing an example in which a method proposed in the present disclosure is performed by a location server.

FIG. 22 illustrates a communication system 1 applied to the present disclosure.

FIG. 23 illustrates wireless devices applicable to the present disclosure.

FIG. 24 illustrates a signal process circuit for a transmission signal.

FIG. 25 illustrates another example of a wireless device applied to the present disclosure.

FIG. 26 illustrates a hand-held device applied to the present disclosure.

### DETAILED DESCRIPTION

Hereinafter, preferred embodiments of the disclosure are described in detail with reference to the accompanying drawings. The following detailed description taken in conjunction with the accompanying drawings is intended for describing example embodiments of the disclosure, but not for representing a sole embodiment of the disclosure. The detailed description below includes specific details to convey a thorough understanding of the disclosure. However, it will be easily appreciated by one of ordinary skill in the art that embodiments of the disclosure may be practiced even without such details.

In some cases, to avoid ambiguity in concept, known structures or devices may be omitted or be shown in block diagrams while focusing on core features of each structure and device.

Hereinafter, downlink (DL) means communication from a base station to a terminal and uplink (UL) means communication from the terminal to the base station. In the downlink, a transmitter may be part of the base station, and a receiver may be part of the terminal. In the uplink, the transmitter may be part of the terminal and the receiver may be part of the base station. The base station may be expressed as a first communication device and the terminal may be expressed as a second communication device. A base station (BS) may be replaced with terms including a fixed station, a Node B, an evolved-NodeB (eNB), a Next Generation NodeB (gNB), a base transceiver system (BTS), an access point (AP), a network (5G network), an AI system, a road side unit (RSU), a vehicle, a robot, an Unmanned Aerial Vehicle (UAV), an Augmented Reality (AR) device, a Virtual Reality (VR) device, and the like. Further, the terminal may be fixed or mobile and may be replaced with terms including a User Equipment (UE), a Mobile Station (MS), a user terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, and a Device-to-Device (D2D) device, the vehicle, the robot, an AI module, the Unmanned Aerial Vehicle (UAV), the Augmented Reality (AR) device, the Virtual Reality (VR) device, and the like.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology such as universal terrestrial radio access (UTRA) or CDMA2000. The TDMA may be implemented by radio technology such as global system for mobile communications (GSM)/general packet radio service (GPRS)/enhanced data rates for GSM evolution (EDGE). The OFDMA may be implemented as radio technology such as IEEE 802.11 (Wi-Fi), IEEE 802.16 (WiMAX), IEEE 802-20, E-UTRA (evolved UTRA), and the like. The UTRA is a part of a universal mobile telecommunication system (UMTS). 3rd generation partnership project (3GPP) long term evolution (LTE), as a part of an evolved UMTS (E-UMTS) using E-UTRA, adopts the OFDMA in the downlink and the SC-FDMA in the uplink. LTE-A (advanced) is the evolution of 3GPP LTE.

For clarity of description, the present disclosure is described based on the 3GPP communication system (e.g., LTE-A or NR), but the technical spirit of the present disclosure are not limited thereto. LTE means technology after 3GPP TS 36.xxx Release 8. In detail, LTE technology after 3GPP TS 36.xxx Release 10 is referred to as the LTE-A and LTE technology after 3GPP TS 36.xxx Release 13 is referred to as the LTE-A pro. The 3GPP NR means technology after TS 38.XXX Release 15. The LTE/NR may be referred to as a 3GPP system. “xxx” means a standard document detail number. The LTE/NR may be collectively referred to as the 3GPP system. Matters disclosed in a standard document published before the present disclosure may refer to a background art, terms, abbreviations, etc., used for describing the present disclosure. For example, the following documents may be referenced.

### 3GPP LTE

36.211: Physical channels and modulation
36.212: Multiplexing and channel coding
36.213: Physical layer procedures
36.300: Overall description
36.331: Radio Resource Control (RRC)

### 3GPP NR

38.211: Physical channels and modulation
38.212: Multiplexing and channel coding
38.213: Physical layer procedures for control
38.214: Physical layer procedures for data
38.300: NR and NG-RAN Overall Description
36.331: Radio Resource Control (RRC) protocol specification

As more and more communication devices require larger communication capacity, there is a need for improved mobile broadband communication compared to the existing radio access technology (RAT). Further, massive machine type communications (MTCs), which provide various services anytime and anywhere by connecting many devices and objects, are one of the major issues to be considered in the next generation communication. In addition, a communication system design considering a service/UE sensitive to reliability and latency is being discussed. As such, the introduction of next-generation radio access technology considering enhanced mobile broadband communication (eMBB), massive MTC (mMTC), ultra-reliable and low latency communication (URLLC) is discussed, and in the present disclosure, the technology is called NR for convenience. The NR is an expression representing an example of 5G radio access technology (RAT).

In a New RAT system including NR uses an OFDM transmission scheme or a similar transmission scheme thereto. The new RAT system may follow OFDM parameters different from OFDM parameters of LTE. Alternatively, the new RAT system may follow numerology of conventional LTE/LTE-A as it is or have a larger system bandwidth (e.g., 100 MHz). Alternatively, one cell may support a plurality of numerologies. In other words, UEs that operate with different numerologies may coexist in one cell.

The numerology corresponds to one subcarrier spacing in a frequency domain. By scaling a reference subcarrier spacing by an integer N, different numerologies may be defined.

### Definition of Terms

eLTE eNB: The eLTE eNB is the evolution of eNB that supports connectivity to EPC and NGC.

gNB: A node which supports the NR as well as connectivity to NGC.

New RAN: A radio access network which supports either NR or E-UTRA or interfaces with the NGC.

Network slice: A network slice is a network defined by the operator customized to provide an optimized solution for a specific market scenario which demands specific requirements with end-to-end scope.

Network function: A network function is a logical node within a network infrastructure that has well-defined external interfaces and well-defined functional behavior.

NG-C: A control plane interface used at an NG2 reference point between new RAN and NGC.

NG-U: A user plane interface used at an NG3 reference point between new RAN and NGC.

Non-standalone NR: A deployment configuration where the gNB requires an LTE eNB as an anchor for control plane connectivity to EPC, or requires an eLTE eNB as an anchor for control plane connectivity to NGC.

Non-standalone E-UTRA: A deployment configuration where the eLTE eNB requires a gNB as an anchor for control plane connectivity to NGC.

User plane gateway: An end point of NG-U interface.

### Overview of System

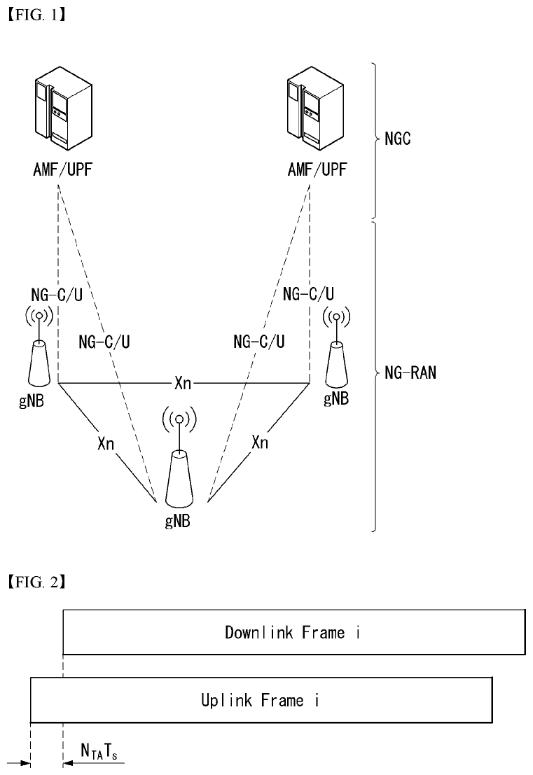

FIG. 1 illustrates an example overall NR system structure to which a method as proposed in the disclosure may apply.

Referring to FIG. 1, an NG-RAN is constituted of gNBs to provide a control plane (RRC) protocol end for user equipment (UE) and NG-RA user plane (new AS sublayer/PDCP/RLC/MAC/PHY).

The gNBs are mutually connected via an Xn interface.

The gNBs are connected to the NGC via the NG interface.

More specifically, the gNB connects to the access and mobility management function (AMF) via the N2 interface and connects to the user plane function (UPF) via the N3 interface. New RAT (NR) numerology and frame structure

In the NR system, a number of numerologies may be supported. Here, the numerology may be defined by the subcarrier spacing and cyclic prefix (CP) overhead. At this time, multiple subcarrier spacings may be derived by scaling the basic subcarrier spacing by integer N (or, M). Further, although it is assumed that a very low subcarrier spacing is not used at a very high carrier frequency, the numerology used may be selected independently from the frequency band.

Further, in the NR system, various frame structures according to multiple numerologies may be supported.

Hereinafter, an orthogonal frequency division multiplexing (OFDM) numerology and frame structure that may be considered in the NR system is described.

The multiple OFDM numerologies supported in the NR system may be defined as shown in Table 1.

TABLE 1

| | Δf = 2^{μ} · 15 | |
|---|---|---|
| μ | [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

NR supports multiple numerologies (or subcarrier spacings (SCS)) for supporting various 5G services. For example, if SCS is 15 kHz, NR supports a wide area in typical cellular bands. If SCS is 30 KHz/60 kHz, NR supports a dense urban, lower latency and a wider carrier bandwidth. If SCS is 60 kHz or higher, NR supports a bandwidth greater than 24.25 GHz in order to overcome phase noise.

An NR frequency band is defined as a frequency range of two types FR1 and FR2. The FR1 and the FR2 may be configured as in Table 1 below. Furthermore, the FR2 may mean a millimeter wave (mmW).

TABLE 2

| Frequency | | |
|---|---|---|
| Range | Corresponding | |
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

With regard to the frame structure in the NR system, the size of various fields in the time domain is expressed as a multiple of time unit of Tₛ=1/(Δfₘₐₓ·N_{f}), where Δfₘₐₓ=480·10³, and N=4096. Downlink and uplink transmissions is constituted of a radio frame with a period of T_{f}=(ΔfₘₐₓN_{f}/100)·Tₛ=10 ms Here, the radio frame is constituted of 10 subframes each of which has a period of T_{sf}=(ΔfₘₐₓN_{f}/1000)·Tₛ=1 ms. In this case, one set of frames for uplink and one set of frames for downlink may exist.

FIG. 2 illustrates a relationship between an uplink frame and downlink frame in a wireless communication system to which a method described in the present disclosure is applicable.

As illustrated in FIG. 2, uplink frame number i for transmission from the user equipment (UE) should begin T_{TA}=N_{TA}Tₛ earlier than the start of the downlink frame by the UE.

For numerology μ, slots are numbered in ascending order of nₛ^{μ}∈{0, . . . , N_{subframe}^{slots,μ}−1} in the subframe and in ascending order of n_{s,f}^{μ}∈{0, . . . , N_{frame}^{slots,μ}−1} in the radio frame. One slot includes consecutive OFDM symbols of N_{symb}^{μ}, and N_{symb}^{μ} is determined according to the used numerology and slot configuration. In the subframe, the start of slot nₛ^{μ} is temporally aligned with the start of nₛ^{μ}N_{symb}^{μ}.

Not all UEs are able to transmit and receive at the same time, and this means that not all OFDM symbols in a downlink slot or an uplink slot are available to be used.

Table 3 represents the number N_{symb}^{slot} of OFDM symbols per slot, the number Nₛₗₒₜ^{frame,μ} of slots per radio frame, and the number Nₛₗₒₜ^{subframe,μ} of slots per subframe in a normal CP. Table 4 represents the number of OFDM symbols per slot, the number of slots per radio frame, and the number of slots per subframe in an extended CP.

TABLE 3

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame,μ} | Nₛₗₒₜ^{subframe,μ} |
|---|---|---|---|
| 2 | 12 | 40 | 4 |

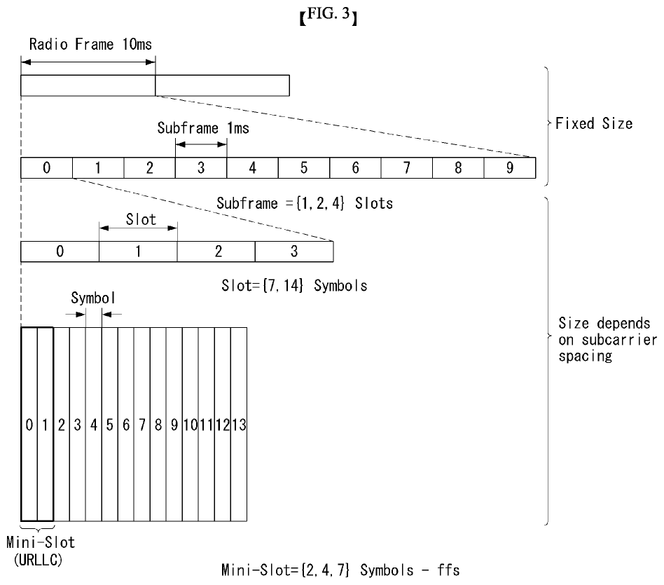

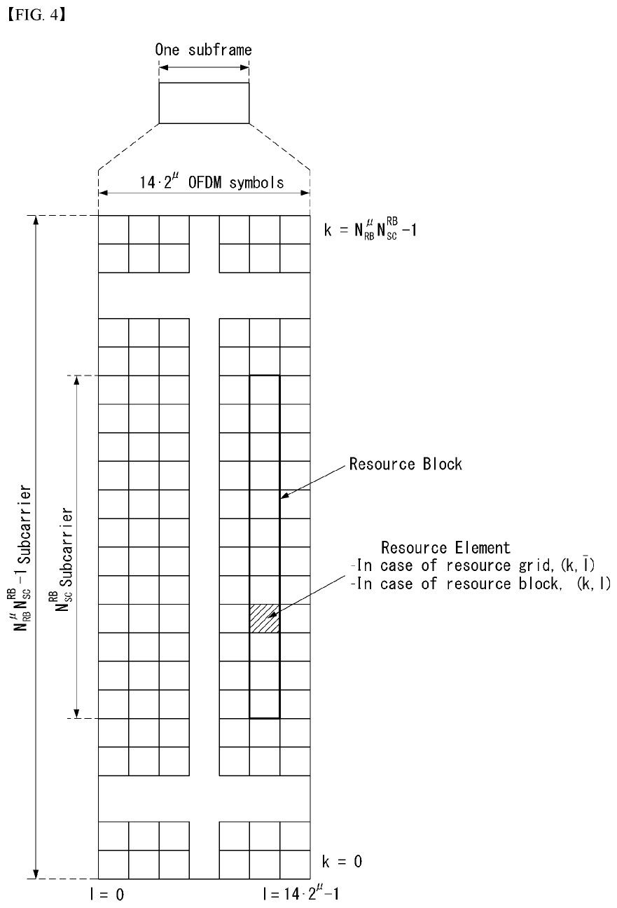

FIG. 3 illustrates an example of a frame structure in a NR system. FIG. 3 is merely for convenience of explanation and does not limit the scope of the present disclosure.

In Table 4, in case of μ=2, i.e., as an example in which a subcarrier spacing (SCS) is 60 kHz, one subframe (or frame) may include four slots with reference to Table 3, and one subframe={1, 2, 4} slots shown in FIG. 3, for example, the number of slot(s) that may be included in one subframe may be defined as in Table 3.

Further, a mini-slot may consist of 2, 4, or 7 symbols, or may consist of more symbols or less symbols.

In regard to physical resources in the NR system, an antenna port, a resource grid, a resource element, a resource block, a carrier part, etc. May be considered.

Hereinafter, the above physical resources that may be considered in the NR system are described in more detail.

First, in regard to an antenna port, the antenna port is defined so that a channel over which a symbol on an antenna port is conveyed may be inferred from a channel over which another symbol on the same antenna port is conveyed. When large-scale properties of a channel over which a symbol on one antenna port is conveyed may be inferred from a channel over which a symbol on another antenna port is conveyed, the two antenna ports may be regarded as being in a quasi co-located or quasi co-location (QC/QCL) relation. Here, the large-scale properties may include at least one of delay spread, Doppler spread, frequency shift, average received power, and received timing.

FIG. 4 illustrates an example of a resource grid supported in a wireless communication system to which a method proposed in the present disclosure is applicable.

Referring to FIG. 4, a resource grid consists of N_{RB}^{μ}N_{sc}^{RB} subcarriers on a frequency domain, each subframe consisting of 14·2μ OFDM symbols, but the present disclosure is not limited thereto.

In the NR system, a transmitted signal is described by one or more resource grids, consisting of N_{RB}^{μ}N_{sc}^{RB} subcarriers, and 2^{μ}N_{symb}^{(μ)} OFDM symbols, where N_{RB}^{μ}≤N_{RB}^{max,μ}. N_{RB}^{max,μ} denotes a maximum transmission bandwidth and may change not only between numerologies but also between uplink and downlink.

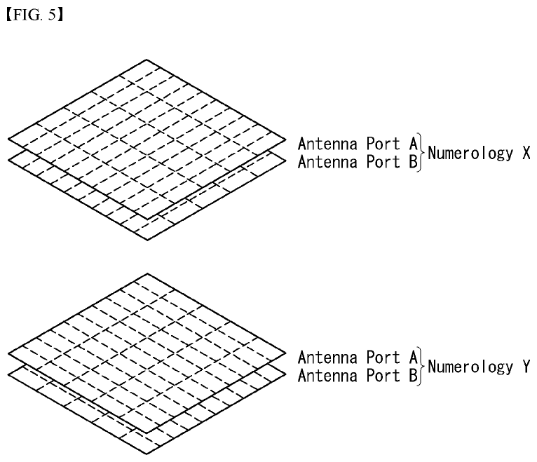

In this case, as illustrated in FIG. 5, one resource grid may be configured per numerology μ and antenna port p.

FIG. 5 illustrates examples of a resource grid per antenna port and numerology to which a method proposed in the present disclosure is applicable.

Each element of the resource grid for the numerology μ and the antenna port p is called a resource element and is uniquely identified by an index pair (k,l̅) where k=0, . . . , N_{RB}^{μ}N_{sc}^{RB}−1 is an index on a frequency domain, and l̅=0, . . . , 2^{μ}N_{symb}^{(μ)}−1 refers to a location of a symbol in a subframe. The index pair (k,l̅) is used to refer to a resource element in a slot, where l=0, . . . , N_{symb}^{μ}−1.

The resource element (k,l̅) for the numerology μ and the antenna port p corresponds to a complex value a_{k,l̅}^{(p,μ)}. When there is no risk for confusion or when a specific antenna port or numerology is not specified, the indexes p and μ may be dropped, and as a result, the complex value may be a_{k,l̅}^{(p)} or a_{k,l̅}.

Further, a physical resource block is defined as N_{sc}^{RB}=12 consecutive subcarriers in the frequency domain.

Point A serves as a common reference point of a resource block grid and may be obtained as follows.
offsetToPointA for PCell downlink represents a frequency offset between the point A and a lowest subcarrier of a lowest resource block that overlaps a SS/PBCH block used by the UE for initial cell selection, and is expressed in units of resource blocks assuming 15 kHz subcarrier spacing for FR1 and 60 kHz subcarrier spacing for FR2;
absoluteFrequencyPointA represents frequency-location of the point A expressed as in absolute radio-frequency channel number (ARFCN).

The common resource blocks are numbered from 0 and upwards in the frequency domain for subcarrier spacing configuration μ.

The center of subcarrier 0 of common resource block 0 for the subcarrier spacing configuration μ coincides with ‘point A’. A common resource block number n_{CRB}^{μ} in the frequency domain and resource elements (k, l) for the subcarrier spacing configuration μ may be given by the following Equation 1.

$${n}_{CRB}^{μ} = ⌊ \frac{k}{{N}_{sc}^{R B}} ⌋ \qquad [ Equation 1 ]$$

Here, k may be defined relative to the point A so that k=0 corresponds to a subcarrier centered around the point A. Physical resource blocks are defined within a bandwidth part (BWP) and are numbered from 0 to N_{BWP,i}^{size}−1, where i is No. Of the BWP. A relation between the physical resource block n_{PRB} in BWP i and the common resource block n_{CRB} may be given by the following Equation 2.

$${n}_{CRB} = {n}_{PRB} + {N}_{BWP , i}^{start} \qquad [ Equation 2 ]$$

Here, N_{BWP,i}^{start} may be the common resource block where the BWP starts relative to the common resource block 0.

### Physical Channel and General Signal Transmission

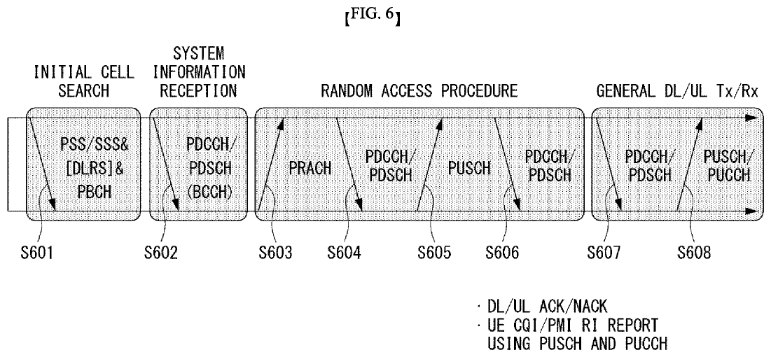

FIG. 6 illustrates physical channels and general signal transmission used in a 3GPP system. In a wireless communication system, the UE receives information from the eNB through Downlink (DL) and the UE transmits information from the eNB through Uplink (UL). The information which the eNB and the UE transmit and receive includes data and various control information and there are various physical channels according to a type/use of the information which the eNB and the UE transmit and receive.

When the UE is powered on or newly enters a cell, the UE performs an initial cell search operation such as synchronizing with the eNB (S601). To this end, the UE may receive a Primary Synchronization Signal (PSS) and a (Secondary Synchronization Signal (SSS) from the eNB and synchronize with the eNB and acquire information such as a cell ID or the like. Thereafter, the UE may receive a Physical Broadcast Channel (PBCH) from the eNB and acquire in-cell broadcast information. Meanwhile, the UE receives a Downlink Reference Signal (DL RS) in an initial cell search step to check a downlink channel status.

A UE that completes the initial cell search receives a Physical Downlink Control Channel (PDCCH) and a Physical Downlink Control Channel (PDSCH) according to information loaded on the PDCCH to acquire more specific system information (S602).

Meanwhile, when there is no radio resource first accessing the eNB or for signal transmission, the UE may perform a Random Access Procedure (RACH) to the eNB (S603 to S606). To this end, the UE may transmit a specific sequence to a preamble through a Physical Random Access Channel (PRACH) (S603 and S605) and receive a response message (Random Access Response (RAR) message) for the preamble through the PDCCH and a corresponding PDSCH. In the case of a contention based RACH, a Contention Resolution Procedure may be additionally performed (S606).

The UE that performs the above procedure may then perform PDCCH/PDSCH reception (S607) and Physical Uplink Shared Channel (PUSCH)/Physical Uplink Control Channel (PUCCH) transmission (S608) as a general uplink/downlink signal transmission procedure. In particular, the UE may receive Downlink Control Information (DCI) through the PDCCH. Here, the DCI may include control information such as resource allocation information for the UE and formats may be differently applied according to a use purpose.

Meanwhile, the control information which the UE transmits to the eNB through the uplink or the UE receives from the eNB may include a downlink/uplink ACK/NACK signal, a Channel Quality Indicator (CQI), a Precoding Matrix Index (PMI), a Rank Indicator (RI), and the like. The UE may transmit the control information such as the CQI/PMI/RI, etc., through the PUSCH and/or PUCCH.

### Beam Management (BM)

A BM procedure as layer 1 (L1)/layer 2 (L2) procedures for acquiring and maintaining a set of base station (e.g., gNB, TRP, etc.) and/or terminal (e.g., UE) beams which may be used for downlink (DL) and uplink (UL) transmission/reception may include the following procedures and terms.
Beam measurement: Operation of measuring characteristics of a beam forming signal received by the eNB or UE.
Beam determination: Operation of selecting a transmit (Tx) beam/receive (Rx) beam of the eNB or UE by the eNB or UE.
Beam sweeping: Operation of covering a spatial region using the transmit and/or receive beam for a time interval by a predetermined scheme.
Beam report: Operation in which the UE reports information of a beamformed signal based on beam measurement.

The BM procedure may be divided into (1) a DL BM procedure using a synchronization signal (SS)/physical broadcast channel (PBCH) Block or CSI-RS and (2) a UL BM procedure using a sounding reference signal (SRS). Further, each BM procedure may include Tx beam sweeping for determining the Tx beam and Rx beam sweeping for determining the Rx beam.

### Downlink Beam Management (DL BM)

The DL BM procedure may include (1) transmission of beamformed DL reference signals (RSS) (e.g., CIS-RS or SS Block (SSB)) of the eNB and (2) beam reporting of the UE.

Here, the beam reporting a preferred DL RS identifier (ID) (s) and L1-Reference Signal Received Power (RSRP).

The DL RS ID may be an SSB Resource Indicator (SSBRI) or a CSI-RS Resource Indicator (CRI).

Hereinafter, matters related to the definition of TRP mentioned in the present specification will be described in detail.

The base station described in this disclosure may be a generic term for an object that transmits/receives data to and from UE. For example, the base station described herein may be a concept including one or more transmission points (TPs), one or more transmission and reception points (TRPs), and the like. For example, multiple TPs and/or multiple TRPs described herein may be included in one base station or included in multiple base stations. In addition, the TP and/or TRP may include a panel of a base station, a transmission and reception unit, and the like.

In addition, the TRP described in this disclosure means an antenna array having one or more antenna elements available in a network located at a specific geographical location in a specific area. Although this disclosure is described with respect to “TRP” for convenience of explanation, the TRP may be replaced with a base station, a transmission point (TP), a cell (e.g., a macro cell/small cell/pico cell, etc.), an antenna array, or a panel and understood and applied as such.

Hereinafter, matters related to positioning in a wireless communication system will be described in detail.

Table 5 below shows definitions of terms used in relation to the positioning.

TABLE 5
Anchor carrier: In NB-IoT, a carrier where the UE assumes that NPSS/NSSS/NPBCH/
SIB-NB are transmitted.
Location Server: a physical or logical entity (e.g., E-SMLC or SUPL SLP) that manages
positioning for a target device by obtaining measurements and other location information
from one or more positioning units and providing assistance data to positioning units to
help determine this. A Location Server may also compute or verify the final location
estimate.
E-SMLC: Evolved Serving Mobile Location Center
SLP: SUPL Location Platform
SUPL: Secure User Plane Location
NB-IoT: NB-IoT allows access to network services via E-UTRA with a channel
bandwidth limited to 200 kHz.
Reference Source: a physical entity or part of a physical entity that provides signals (e.g.,
RF, acoustic, infra-red) that can be measured (e.g., by a Target Device) in order to obtain
the location of a Target Device.
Target Device: the device that is being positioned (e.g., UE or SUPL SET).
Transmission Point (TP): A set of geographically co-located transmit antennas
for one cell, part of one cell or one PRS-only TP. Transmission Points can include
base station (ng-eNB or gNB) antennas, remote radio heads, a remote antenna of
a base station, an antenna of a PRS-only TP, etc. One cell can be formed by one
or multiple transmission points. For a homogeneous deployment, each
transmission point may correspond to one cell.
Observed Time Difference Of Arrival (OTDOA): The time interval that is
observed by a target device between the reception of downlink signals from two
different TPs. If a signal from TP 1 is received at the moment t₁, and a signal from
TP 2 is received at the moment t₂, the OTDOA is t₂ − t₁.
PRS-only TP: A TP which only transmits PRS signals for PRS-based TBS positioning
and is not associated with a cell.
expected RSTD (from 36.355):
1) If PRS is transmitted:
This field indicates the RSTD value that the target device is expected to measure between
this cell and the assistance data reference cell. The expectedRSTD field takes into account
the expected propagation time difference as well as transmit time difference of PRS
positioning occasions between the two cells. The RSTD value can be negative and is
calculated as (expectedRSTD-8192). The resolution is 3×Tₛ, with Tₛ=1/(15000*2048)
seconds.
2) If PRS is not transmitted:
This field indicates the RSTD value that the target device is expected to measure between
this cell and the assistance data reference cell. The expectedRSTD field takes into account
the expected propagation time difference as well as transmit time difference between the
two cells. The RSTD value can be negative and is calculated as (expectedRSTD-8192).
The resolution is 3×Tₛ, with Tₛ=1/(15000*2048) seconds.
expectedRSTD-Uncertainty (from 36.355):
1) If PRS is transmitted:
This field indicates the uncertainty in expectedRSTD value. The uncertainty is related to
the location server's a-priori estimation of the target device location. The expectedRSTD
and expectedRSTD-Uncertainty together define the search window for the target device.
The scale factor of the expectedRSTD-Uncertainty field is 3×Tₛ, with Tₛ=1 Tₛ=1/(15000*2048
) seconds.
The target device may assume that the beginning of the PRS occasion group of the PRS
configuration with the longest PRS occasion group periodicity (NOTE) of the neighbour
cell is received within the search window of size
[- expectedRSTD-Uncertainty×3×Tₛ, expectedRSTD-Uncertainty×3×Tₛ] centered at
T_{REF} + 1 millisecond×N + (expectedRSTD□8192) ×3×Tₛ, where T_{REF} is the reception ti
me of the beginning of the first PRS occasion group of the first PRS configuration of the
assistance data reference cell at the target device antenna connector, N = 0 when the EA
RFCN of the neighbour cell is equal to that of the assistance data reference cell, and N =
prs-SubframeOffset otherwise.
2) If PRS is not transmitted:
This field indicates the uncertainty in expectedRSTD value. The uncertainty is related to
the location server's a-priori estimation of the target device location. The expectedRSTD
and expectedRSTD-Uncertainty together define the search window for the target device.
The scale factor of the expectedRSTD-Uncertainty field is 3×Tₛ, with Tₛ=1/(15000*2048
) seconds.
If Tₓ is the reception time of the beginning of the subframe X of the assistance data
reference cell at the target device antenna connector, the target device may assume that
the beginning of the closest subframe of this neighbour cell to subframe X is received
within the search window of size [-expectedRSTD-Uncertainty×3×Tₛ, expectedRSTD-
Uncertainty×3×Tₛ] centered at Tₓ + (expectedRSTD-8192) ×3×Tₛ,

The following shows definitions of abbreviations used in relation to the above positioning.
5GS: 5G System
AoA: Angle of Arrival
AP: Access Point
BDS: BeiDou Navigation Satellite System
BSSID: Basic Service Set Identifier
CID: Cell-ID (positioning method)
E-SMLC: Enhanced Serving Mobile Location Centre
E-CID: Enhanced Cell-ID (positioning method)
ECEF: Earth-Centered, Earth-Fixed
ECI: Earth-Centered-Inertial
EGNOS: European Geostationary Navigation Overlay Service
E-UTRAN: Evolved Universal Terrestrial Radio Access Network
GAGAN: GPS Aided Geo Augmented Navigation
GLONASS: GLObal'naya NAvigatsionnaya Sputnikovaya Sistema (Engl.: Global
Navigation Satellite System)
GMLC: Gateway Mobile Location Center
GNSS: Global Navigation Satellite System
GPS: Global Positioning System
HESSID: Homogeneous Extended Service Set Identifier
LCS: LoCation Services
LMF: Location Management Function
LPP: LTE Positioning Protocol
MBS: Metropolitan Beacon System
MO-LR: Mobile Originated Location Request
MT-LR: Mobile Terminated Location Request
NG-C: NG Control plane
NG-AP: NG Application Protocol
NI-LR: Network Induced Location Request
NRPPa: NR Positioning Protocol A
OTDOA: Observed Time Difference Of Arrival
PDU: Protocol Data Unit
PRS: Positioning Reference Signal
QZSS: Quasi-Zenith Satellite System
RRM: Radio Resource Management
RSSI: Received Signal Strength Indicator
RSTD: Reference Signal Time Difference/Relative Signal Time Difference
SBAS: Space Based Augmentation System
SET: SUPL Enabled Terminal
SLP: SUPL Location Platform
SSID: Service Set Identifier
SUPL: Secure User Plane Location
TADV: Timing Advance
TBS: Terrestrial Beacon System
TOA: Time of Arrival
TP: Transmission Point (TRP: Transmission and Reception Point)
UE: User Equipment
WAAS: Wide Area Augmentation System
WGS-84: World Geodetic System 1984
WLAN: Wireless Local Area Network

### Positioning

Positioning may mean determining the geographic location and/or speed of the UE by measuring a radio signal. The location information may be requested by a client (e.g. an application) related to the UE and reported to the client. In addition, the location information may be included in a core network or may be requested by a client connected to the core network. The location information may be reported in a standard format such as cell-based or geographic coordinates, and in this case, the estimation error values for the location (position) and speed of the UE and/or the positioning measurement method used for positioning may be reported together.

### Positioning Protocol Configuration

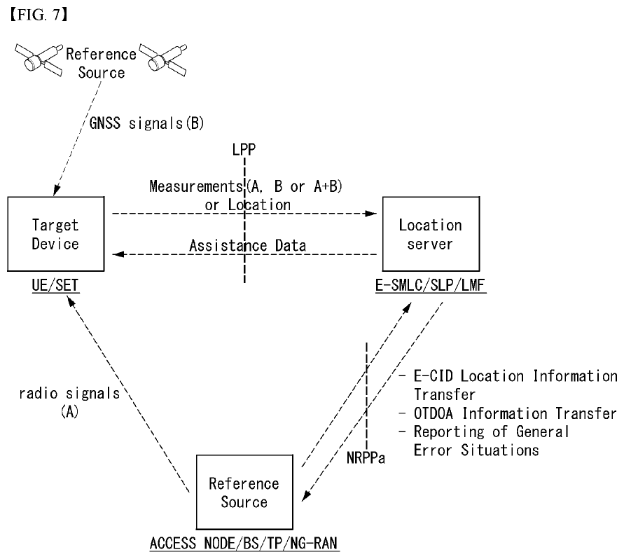

FIG. 7 is a diagram illustrating an example of a positioning protocol configuration for measuring a location of a user equipment (UE).

Referring to FIG. 7, LPP may be used as a point-to-point between a location server (E-SMLC and/or SLP and/or LMF) and a target device to position the target device (UE and/or SET) based on position-related measurements obtained from one or more reference sources. The target device and the location server may exchange measurement and/or location information based on signal A and/or signal B through the LPP.

NRPPa may be used to exchange information between the reference source (ACCESS NODE and/or BS and/or TP and/or NG-RAN nodes) and the location server.

Functions provided by the NRPPa protocol may include the following.
E-CID Location Information Transfer: Through this function, location information may be exchanged between the reference source and the LMF for E-CID positioning purposes.
OTDOA Information Transfer: Through this function, information may be exchanged between the reference source and the LMF for OTDOA positioning purposes.
Reporting of General Error Situations: Through this function, a general error situation in which an error message for each function is not defined may be reported.

### PRS Mapping

For positioning, a positioning reference signal (PRS) may be used. The PRS is a reference signal used for position estimation of the UE.

PRS mapping in a wireless communication system to which embodiments are applicable in the present disclosure may be performed based on Table 6 below.

```
TABLE 6
7.2   Physical resources
The following antenna ports are defined for the downlink:
    Antenna ports starting with 5000 for positioning reference signals
The UE shall not assume that two antenna ports are quasi co-located with respect to any QCL
type unless specified otherwise.
7.4.1.7 Positioning reference signals
7.4.1.7.1  General
A positioning frequency layer consists of one or more downlink PRS resource sets, each of
which consists of one or more downlink PRS resources as described in [6, TS 38.214].
7.4.1.7.2  Sequence generation
The UE shall assume the reference-signal sequence r(m) is defined by
$r ( m ) = \frac{1}{\sqrt{2}} ( 1 - 2 c ( m ) ) + j \frac{1}{\sqrt{2}} ( 1 - 2 c ( m + 1 ) )$
where the pseudo-random sequence c(i) is defined in clause 5.2.1. The pseudo-random
sequence generator shall be initialised with
${c}_{init} = ( {2}^{22} ⌊ \frac{\text{?}}{\text{?}} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + \\ ( {n}_{ID , seq}^{PRS} mod 1024 ) mod {2}^{31}$
where ns,f^{μ} is the slot number, the downlink PRS sequence ID n_{ID,seq}^{PRS} ∈ {0, 1, . . ., 4095} is
given by the higher-layer parameter DL-PRS-SequenceId, and l is the OFDM symbol within
the slot to which the sequence is mapped.
7.4.1.7.3  Mapping to physical resources in a downlink PRS resource
For each downlink PRS resource configured, the UE shall assume the sequence r(m) is
scaled with a factor β_{PRS} and mapped to resources elements (k, l)_{p,μ} according to
                      a_{k,l}^{(p,μ)} = β_{PRS} r(m)
                        m = 0, 1, . . .
                          k = mK_{comb}^{PRS} + ((k_{offset}^{PRS} + k′) mod K_{comb}^{PRS})
                          l = lₛₜₐᵣₜ^{PRS}, lₛₜₐᵣₜ^{PRS} + 1, . . . lₛₜₐᵣₜ^{PRS} + L_{PRS} − 1
when the following conditions are fulfilled:
    the resource element (k, l)_{p,μ} is within the resource blocks occupied by the downlink
PRS resource for which the UE is configured:
    the symbol l is not used by any SS/PBCH block used by the serving cell for downlink
PRS transmitted from the serving cell or indicated by the higher-layer parameter SSB-
positionInBurst for downlink PRS transmitted from a non-serving cell;
    the slot number satisfies the conditions in clause 7.4.1.7.4. [TS 38.211]
and where
    lₛₜₐᵣₜ^{PRS} is the first symbol of the downlink PRS within a slot and given by the higher-
layer parameter DL-PRS-ResourceSymbolOffset;
    the size of the downlink PRS resource in the time domain L_{PRS} ∈ {2, 4, 6, 12} is given
by the higher-layer parameter DL-PRS-NumSymbols;
    the comb size K_{comb}^{PRS} ∈ {2, 4, 6, 12} is given by the higher-layer parameter
transmissionComb;
    the resource-element offset k_{offset}^{PRS} ∈ {0, 1, . . . , K_{comb}^{PRS} − 1} is given by the higher-layer
parameter
combOffset;
    the quantity k′ is given by Table 7.4.1.7.3-1.
The reference point for k = 0 is the location of the point A of the positioning frequency layer,
in which the downlink PRS resource is configured where point A is given by the higher-layer
parameter DL-PRS-PointA.
Table 7.4.1.7.3-1: The frequency offset k′ as a function of l − lₛₜₐᵣₜ^{PRS}.
```

| | Symbol number within the downlink PRS resource l − lₛₜₐᵣₜ^{PRS} | | | | | | | | | | | |
|---|---|---|---|---|---|---|---|---|---|---|---|---|
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

```
7.4.1.7.4  Mapping to slots in a downlink PRS resource set
For a downlink PRS resource in a downlink PRS resource set, the UE shall assume the
downlink PRS resource being transmitted when the slot and frame numbers fulfil
(Nₛₗₒₜ^{frame,μ} n_{f} + n_{s,f}^{μ} − T_{offset}^{PRS} − T_{offset,res}^{PRS}) mod 2^{μ}Tₚₑᵣ^{PRS} ∈ {iT_{gap}^{PRS}} [symbol]
and one of the following conditions are fulfilled:
    the higher-layer parameter DL-PRS-MutingPattern is not provided;
    the higher-layer parameter DL-PRS-MutingPattern is provided and bitmap {b¹} but
not bitmap {b²} is provided, and bit bᵢ¹ is set;
    the higher-layer parameter DL-PRS-MutingPattern is provided and bitmap {b²} but
not bitmap {b¹} is provided, and bit bᵢ² is set;
    the higher-layer parameter DL-PRS-MutingPattern is provided and both bitmaps
{b¹} and {b²} are provided, and both bit bᵢ¹ and bᵢ² are set.
where
    bᵢ¹ is bit i = └(Nₛₗₒₜ^{frame,μ} n_{f} + n_{s,f}^{μ} − T_{offset}^{PRS} − T_{offset,res}^{PRS})/(2^{μ}T_{muting}^{PRS} Tₚₑᵣ^{PRS})┘mod L in
the bitmap given by the higher-layer parameter DL-PRS-MutingPattern where L ∈
{2, 4, 8, 16, 32} is the size of the bitmap;
└((Nₛₗₒₜ^{frame,μ} n_{f} + n_{s,f}^{μ} − T_{offset}^{PRS} − T_{offset,res}^{PRS}) mod 2^{μ}Tₚₑᵣ^{PRS})/T_{gap}^{PRS}┘ mod Tₚₑᵣ^{PRS} in the bitmap [symbol]
given by the higher-layer parameter DL-PRS-MutingPattern;
    the slot offset T_{offset}^{PRS} ∈ {0, 1, . . . , Tₚₑᵣ^{PRS} − 1} is given by the higher-layer parameter
DL-PRS-ResourceSetSlotOffset;
    the downlink PRS resource slot offset T_{offset,res}^{PRS} is given by the higher-layer parameter
DL-PRS-ResourceSlotOffset;
    the periodicity Tₚₑᵣ^{PRS} ∈
{4, 5, 8, 10, 16, 20, 32, 40, 64, 80, 160, 320, 640, 1280, 2560, 5120, 10240} is given by the
higher-layer parameter DL-PRS-Periodicity;
    the repetition factor Tᵣₑₚ^{PRS} ∈ {1, 2 ,4, 6, 8, 16, 32} is given by the higher-layer parameter
DL-PRS-ResourceRepetitionFactor;
    the muting repetition factor T_{muting}^{PRS} is given by the higher-layer parameter DL-PRS-
MutingBitRepetitionFactor;
    the time gap T_{gap}^{PRS} ∈ {1, 2, 4, 8, 16, 32} is given by the higher-layer parameter DL-
PRS-ResourceTimeGap;
For a downlink PRS resource in a downlink PRS resource set configured, the UE shall assume
the downlink PRS resource being transmitted as described in clause 5.1.6.4 of [6, TS 38.214]. [symbol]
indicates data missing or illegible when filed
```

### PRS Reception Procedure

The PRS reception procedure of the UE in a wireless communication system to which embodiments are applicable in the present disclosure may be performed based on Table 7 below.

```
TABLE 7
5.1.6.5 PRS reception procedure
The UE can be configured with one or more DL PRS resource set configuration(s) as
indicated by the higher layer parameters DL-PRS-ResourceSet and DL-PRS-Resource. Each
DL PRS resource set consists of K≥1 DL PRS resource(s) where each has an associated
spatial transmission filter. The UE can be configured with one or more DL PRS Positioning
Frequency Layer configuration(s) as indicated by the higher layer parameter DL-PRS-
PositioningFrequencyLayer. A DL PRS Positioning Frequency Layer is defined as a
collection of DL PRS Resource Sets which have common parameters configured by DL-
PRS-PositioningFrequency Layer.
The UE assumes that the following parameters for each DL PRS resource(s) are configured
via higher layer parameters DL-PRS-PositioningFrequencyLayer, DL-PRS-ResourceSet and
DL-PRS-Resource.
A positioning frequency layer consists of one or more PRS resource sets and it is defined by:
  DL-PRS-SubcarrierSpacing defines the subcarrier spacing for the DL PRS resource.
All DL PRS Resources and DL PRS Resource sets in the same DL-PRS-
PositioningFrequencyLayer have the same value of DL-PRS-SubcarrierSpacing. The
supported values of DL-PRS-SubcarrierSpacing are given in Table 4.2-1 of [4, TS38.211].
  DL-PRS-CyclicPrefix defines the cyclic prefix for the DL PRS resource. All DL
PRS Resources and DL PRS Resource sets in the same DL-PRS-PositioningFrequencyLayer
have the same value of DL-PRS-CyclicPrefix. The supported values of DL-PRS-CyclicPrefix
are given in Table 4.2-1 of [4, TS38.211].
  DL-PRS-PointA defines the absolute frequency of the reference resource block. Its
lowest subcarrier is also known as Point A. All DL PRS resources belonging to the same DL
PRS Resource Set have common Point A and all DL PRS Resources sets belonging to the
same DL-PRS-PositioningFrequencyLayer have a common Point A.
The UE expects that it will be configured with [IDs] each of which is defined such that it is
associated with multiple DL PRS Resource Sets from the same cell. The UE expects that one
of these [IDs] along with a DL-PRS-ResourceSetId and a DL-PRS-ResourceId can be used
to uniquely identify a DL PRS Resource.
A PRS resource set consists of one or more PRS resources and it is defined by:
  DL-PRS-ResourceSetId defines the identity of the DL PRS resource set
configuration.
Tₚₑᵣ^{PRS} ∈ DL-PRS-Periodicity defines the DL PRS resource periodicity and takes values
2^{μ}{4, 8, 16, 32, 64, 5, 10, 20, 40, 80, 160, 320, 640, 1280, 2560, 5120, 10240, 20480}
slots, where μ = 0, 1, 2, 3 for DL-PRS-SubcarrierSpacing=15, 30, 60 and 120kHz
respectively. Tₚₑᵣ^{PRS} = 2^{μ} · 20480 is not supported for μ = 0. All the DL PRS resources within
one resource set are configured with the same periodicity.
  DL-PRS-ResourceRepetitionFactor defines how many times each DL-PRS resource
is repeated for a single instance of the DL-PRS resource set and takes values Tₚₑᵣ^{PRS} ∈
{1,2,4,6,8,16,32},. All the DL PRS resources within one resource set have the same
ResourceRepetitionFactor
  DL-PRS-ResourceTimeGap defines the offset in number of slots between two
repeated instances of a DL PRS resource with the same DL-PRS-ResourceID within a single
instance of the DL PRS resource set and takes values T_{gap}^{PRS} ∈ {1,2,4,8,16,32}. The UE only
expects to be configured with DL-PRS-ResourceTimeGap if DL-PRS-
ResourceRepetitionFactor is configured with value greater than 1. The time duration spanned
by one instance of a DL-PRS-ResourceSet is not expected to exceed the configured value of
DL-PRS-Periodicity. All the DL PRS resources within one resource set have the same DL-
PRS-ResourceTimeGap.
  DL-PRS-MutingPattern defines a bitmap of the time locations where the DL PRS
resource is expected to not be transmitted for a DL PRS resource set. The bitmap size can be
{2, 4, 8, 16, 32} bits
long. The bitmap has two options for applicability. In the first option each bit in the bitmap
corresponds to a configurable number of consecutive instances of a DL-PRS-ResourceSet
where all the DL-PRS-Resources within the set are muted for the instance that is indicated to
be muted. In the second option each bit in the bitmap corresponds to a single repetition index
for each of the DL-PRS-Resources within each instance of a DL-PRS-ResourceSet and the
length of the bitmap is equal to DL-PRS-ResourceRepetitionFactor. Both options may be
configured at the same time in which case the logical AND operation is applied to the bit
maps as described in clause 7.4.1.7.4 of [4, TS 38.211].
  DL-PRS-SFN0-Offset defines the time offset of the SFN0 slot 0 for the transmitting
cell with respect to SFN0 slot 0 of [FFS in RAN2].
  DL-PRS-ResourceSetSlotOffset defines the slot offset with respect to SFN0 slot 0
and takes values T_{offset}^{PRS} ∈ {0,1,...,Tₚₑᵣ^{PRS} — 1}.
  DL-PRS-CombSizeN defines the comb size of a DL PRS resource where the
allowable values are given in Clause 7.4.1.7.1 of [TS38.211]. All DL PRS resource sets
belonging to the same positioning frequency layer have the sam evalue of DL-PRS-
combSizeN.
  DL-PRS-ResourceBandwidth defines the number of resource blocks configured for
PRS transmission. The parameter has a granularity of 4 PRBs with a minimum of 24 PRBs
and a maximum of 272 PRBs. All DL PRS resources sets within a positioning frequency
layer have the same value of DL-PRS-ResourceBandwidth.
A PRS resource is defined by:
  DL-PRS-ResourceList determines the DL PRS resources that are contained within
one DL PRS resource set.
  DL-PRS-ResourceId determines the DL PRS resource configuration identity. All DL
PRS resource IDs are locally defined within a DL PRS resource set.
  DL-PRS-SequenceId is used to initialize cinit value used in pseudo random generator
[4, TS38.211, 7.4.1.7.2] for generation of DL PRS sequence for a given DL PRS resource.
  DL-PRS-ReOffset defines the starting RE offset of the first symbol within a DL PRS
resource in frequency. The relative RE offsets of the remaining symbols within a DL PRS
resource are defined based on the initial offset and the rule described in Clause 7.4.1.7.3 of
[4, TS38.211].
  DL-PRS-ResourceSlotOffset determines the starting slot of the DL PRS resource
with respect to corresponding DL-PRS-ResourceSetSlotOffset
  DL-PRS-ResourceSymbolOffset determines the starting symbol of the DL PRS
resource within the starting slot.
  DL-PRS-NumSymbols defines the number of symbols of the DL PRS resource
within a slot where the allowable values are given in Clause 7.4.1.7.1 of [4, TS38.211].
  DL-PRS-QCL-Info defines any quasi-colocation information of the DL PRS
resource with other reference signals. The DL PRS may be configured to be ‘QCL-Type-D’
with a DL PRS or SS/PBCH Block from a serving cell or a non-serving cell. The DL PRS
may be configured to be ‘QCL-Type-C’ with a SS/PBCH Block from a serving or non-
serving cell. If the DL PRS is configured as both ‘QCL-Type-C’ and ‘QCL-Type-D’ with a
SS/PBCH Block then the SSB index indicated should be the same.
  DL-PRS-StartPRB defines the starting PRB index of the DL PRS resource with
respect to reference Point A. The starting PRB index has a granularity of one PRB with a
minimum value of 0 and a maximum value of 2176 PRBs. All DL PRS Resource Sets
belonging to the same Positioning Frequency Layer have the same value of Start PRB.
The UE assumes constant EPRE is used for all REs of a given DL PRS resource.
The UE may be indicated by the network that a DL PRS resources can be used as the
reference for the RSTD measurement in a higher layer parameter DL-PRS-
RstdReferenceInfo. The reference time indicated by the network to the UE can also be used
by the UE to determine how to apply higher layer parameters DL-PRS-expectedRSTD and
DL-PRS-expectedRSTD-uncertainty. The UE expects the
reference time to be indicated whenever it is expected to receive the DL PRS. This reference
time provided by DL-PRS-RstdReferenceInfo may include an [ID], a PRS resource set ID,
and optionally a single PRS resource ID or a list of PRS resource IDs. The UE may use
different DL PRS resources or a different DL PRS resource set to determine the reference
time for the RSTD measurement as long as the condition that the DL PRS resources used
belong to a single DL PRS resource set is met. If the UE chooses to use a different reference
time than indicated by the network, then it is expected to report the DL PRS resource ID(s)
or the DL PRS resource set ID used to determine the reference.
The UE may be configured to report quality metrics corresponding to the RSTD and UE Rx-
Tx time difference measurements which include the following fields:
  TimingMeasQuality-Value which provides the best estimate of the uncertainty of the
measurement
  TimingMeasQuality-Resolution which specifies the resolution levels used in the
Value field
The UE expects to be configured with higher layer parameter DL-PRS-expectedRSTD,
which defines the time difference with respect to the received DL subframe timing the UE is
expected to receive DL PRS, and DL-PRS-expectedRSTD-uncertainty, which defines a
search window around the expectedRSTD.
For DL UE positioning measurement reporting in higher layer parameters DL-PRS-
RstdMeasurementInfo or DL-PRS-UE-Rx-Tx-MeasurementInfo the UE can be configured
to report the DL PRS resource ID(s) or the DL PRS resource set ID(s) associated with the
DL PRS resource(s) or the DL PRS resource set(s) which are used in determining the UE
measurements DL RSTD, UE Tx-Rx time difference or the DL PRS-RSRP.
The UE can be configured in higher layer parameter UE Rx-Tx Time-MeasRequestInfo to
report multiple UE Rx-Tx time difference measurements corresponding to a single
configured SRS resource or resource set for positioning. Each measurement corresponds to
a single received DL PRS resource or resource set which can be in difference positioning
frequency layers.
For the DL RSTD, DL PRS-RSRP, and UE Rx-Tx time difference measurements the UE can
report an associated higher layer parameter Timestamp. The Timestamp can include the SFN
and the slot number for a subcarrier spacing. These values correspond to the reference which
is provided by DL-PRS-RSTDReferenceInfo.
The UE is expected to measure the DL PRS resource outside the active DL BWP or with a
numerology different from the numerology of the active DL BWP if the measurement is
made during a configured measurement gap. When not configured with a measurement gap,
the UE is only required to measure DL PRS within the active DL BWP and with the same
numerology as the active DL BWP. If the UE is not provided with a measurement gap, the
UE is not expected to process DL PRS resources on serving or non-serving cells on any
symbols indicated as UL by the serving cell. When the UE is expected to measure the DL
PRS resource outside the active DL BWP it may request a measurement gap in higher layer
parameter [XYZ].
The UE assumes that for the serving cell the DL PRS is not mapped to any symbol that
contains SS/PBCH. If the time frequency location of the SS/PBCH block transmissions from
non-serving cells are provided to the UE then the UE also assumes that the DL PRS is not
mapped to any symbol that contains the SS/PBCH block of the non-serving cell.
The UE may be configured to report, subject to UE capability, up to 4 DL RSTD
measurements per pair of cells with each measurement between a different pair of DL PRS
resources or DL PRS resource sets within the DL PRS configured for those cells. The up to
4 measurements being performed on the same pair of cells and all DL RSTD measurements
in the same report use a single reference timing.
The UE may be configured to measure and report up to 8 DL PRS RSRP measurements on
different DL PRS resources from the same cell. When the UE reports DL PRS RSRP
measurements from one DL PRS resource set, the UE may indicate which DL PRS RSRP
measurements have been
performed using the same spatial domain filter for reception.
If the UE is configured with DL-PRS-QCL-Info and the QCL relation is between two DL
PRS resources, then the UE assumes those DL PRS resources are from the same cell. If DL-
PRS-QCL-Info is configured to the UE with ‘QCL-Type-D’ with a source DL-PRS-Resource
then the DL-PRS-ResourceSetId and the DL-PRS-ResourceId of the source DL-PRS-
Resource are expected to be indicated to the UE.
The UE does not expect to process the DL PRS in the same symbol where other DL signals
and channels are transmitted to the UE when there is no measurement gap configured to the
UE.
```

### Positioning Architecture

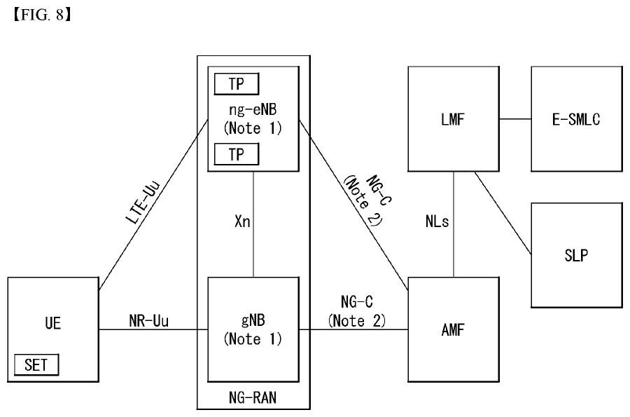

FIG. 8 is a diagram illustrating an example of architecture of a system for measuring a location of an UE.

Referring to FIG. 8, the AMF (Core Access and Mobility Management Function) may receive a request for location service related to a specific target UE from another entity such as the GMLC (Gateway Mobile Location Center), or may decide to start the location service on behalf of the specific target UE in the AMF itself. Then, the AMF transmits a location service request to the LMF (Location Management Function). The LMF receiving the location service request may process the location service request and return a processing result including the estimated location of the UE to the AMF. On the other hand, based on the location service request being received from another entity such as the GMLC other than the AMF, the AMF may transmit the processing result received from the LMF to another entity.

New generation evolved-NB (ng-eNB) and gNB may be network elements of NG-RAN that can provide measurement results for location tracking, and measure a radio signal for the target UE and transmit the result to the LMF. In addition, the ng-eNB may control some TPs (Transmission Points), such as remote radio heads, or PRS-only TPs supporting a PRS-based beacon system for E-UTRA.

The LMF may be connected to an Enhanced Serving Mobile Location Center (E-SMLC), and the E-SMLC may enable the LMF to access the E-UTRAN. For example, the E-SMLC may enable the LMF to support Observed Time Difference Of Arrival (OTDOA) which is one of the E-UTRAN positioning measurement methods, based on the downlink measurement which is obtained by the target UE through a signal transmitted from TPs dedicated for PRS in the eNB and/or E-UTRAN.

Meanwhile, the LMF may be connected to a SUPL Location Platform (SLP). The LMF may support and manage different location services for target UEs. The LMF may interact with the serving ng-eNB or serving gNB for the target UE to obtain the location measurement of the UE. For positioning of the target UE, the LMF may determine a positioning measurement method based on Location Service (LCS) client type, required QoS (Quality of Service), UE positioning capabilities, and gNB positioning capabilities and ng-eNB positioning capabilities, and apply this positioning measurement method to the serving gNB and/or the serving ng-eNB. Then, the LMF may determine a position estimate for the target UE and additional information such as accuracy of the position estimate and velocity. The SLP is a SUPL (Secure User Plane Location) entity responsible for positioning through a user plane.

The UE may measure the location of the UE by utilizing a downlink reference signal transmitted from the NG-RAN and the E-UTRAN. In this case, the downlink reference signal transmitted from the NG-RAN and the E-UTRAN to the UE may include an SS/PBCH block, CSI-RS and/or PRS, etc., and whether to measure the location of the UE using any downlink reference signal may depend on a configuration such as LMF/E-SMLC/ng-eNB/E-UTRAN, etc. In addition, the location of the UE may be measured in a RAT-independent method using different GNSS (Global Navigation Satellite System), TBS (Terrestrial Beacon System), WLAN access points, Bluetooth beacon and a sensor (e.g. barometric pressure sensor) built into the UE. The UE may include an LCS application, and access the LCS application through communication with a network to which the UE is connected or other applications included in the UE. The LCS application may include measurement and calculation functions necessary to determine the location of the UE. For example, the UE may include an independent positioning function such as Global Positioning System (GPS), and may report the location of the UE independently of NG-RAN transmission. The independently acquired positioning information may be utilized as auxiliary information of positioning information acquired from the network.

### Position Measurement Procedure

FIG. 9 is a diagram illustrating an example of a procedure for measuring a location of a UE.

When the UE is in CM-IDLE (Connection Management-IDLE) state, when the AMF receives a location service request, the AMF may establish a signaling connection with the UE, and request a network trigger service to allocate a specific serving gNB or ng-eNB. This operation process is omitted in FIG. 9. That is, in FIG. 8, it may be assumed that the UE is in a connected mode. However, the signaling connection may be released during the positioning process by the NG-RAN for reasons such as signaling and data inactivity.

Looking at the operation process of the network for measuring the location of the UE in detail with reference to FIGS. 8 and 9, in step 1a, a 5GC entity such as GMLC may request a location service for measuring the location of a target UE with a serving AMF. However, even if the GMLC does not request the location service, based on step 1b, the serving AMF may determine that the location service is necessary for measuring the location of the target UE. For example, in order to measure the location of the UE for an emergency call, the serving AMF may decide to directly perform the location service.

Then, based on step 2, the AMF may send a location service request to the LMF, and based on step 3a, the LMF may initiate location procedures for obtaining location measurement data or location measurement assistance data together with the serving ng-eNB and the serving gNB. For example, the LMF may request location-related information related to one or more UEs to the NG-RAN, and instruct the type of location information required and the associated QoS. Then, in response to the request, the NG-RAN may transmit the location-related information to the LMF. In this case, based on the method for determining the location by the request being E-CID, the NG-RAN may transmit additional location-related information to the LMF through one or more NRPPa messages. Here, ‘location-related information’ may mean all values used for location calculation, such as actual location estimation information and wireless measurement or location measurement, etc. In addition, the protocol used in step 3a may be an NRPPa protocol, which will be described later.

Additionally, based on step 3b, the LMF may initiate location procedures for downlink positioning with the UE. For example, the LMF may send location assistance data to the UE, or obtain a location estimate or location measurement. For example, in step 3b, a capability transfer process may be performed. Specifically, the LMF may request capability information from the UE, and the UE may transmit capability information to the LMF. In this case, the capability information may include information on a location measurement method that the LFM or UE can support, information on various aspects of a specific location measurement method, such as various types of assistance data for A-GNSS, and information on common characteristics that are not limited to any one location measurement method, such as the ability to handle multiple LPP transactions, etc. Meanwhile, in some cases, even if the LMF does not request capability information from the UE, the UE may provide capability information to the LMF.

As another example, a location assistance data transfer process may be performed in step 3b. Specifically, the UE may request location assistance data from the LMF, and may indicate required specific location assistance data to the LMF. Then, the LMF may deliver location assistance data corresponding thereto to the UE, and additionally, may transmit additional assistance data to the UE through one or more additional LPP messages. On the other hand, location assistance data transmitted from the LMF to the UE may be transmitted through a unicast method, and in some cases, the LMF may transmit location assistance data and/or additional assistance data to the UE without the UE requesting assistance data from the LMF.

As another example, a location information transfer process may be performed in step 3b. Specifically, the LMF may request the UE for location-related information related to the UE, and may indicate the type of location information required and the associated QoS. Then, in response to the request, the UE may transmit the location related information to the LMF. In this case, the UE may additionally transmit additional location-related information to the LMF through one or more LPP messages. Here, ‘location-related information’ may mean all values used for location calculation, such as actual location estimation information and wireless measurement or location measurement, etc, and representatively, there may be a Reference Signal Time Difference (RSTD) value measured by the UE based on downlink reference signals transmitted from a plurality of NG-RAN and/or E-UTRAN to the UE. Similar to the above, the UE may transmit the location-related information to the LMF even if there is no request from the LMF.

On the other hand, the processes made in step 3b described above may be performed independently, but may be performed continuously. In general, step 3b is performed in the order of a capability transfer process, an assistance data transfer process, and a location information transfer process, but is not limited to this order. In other words, step 3b is not limited to a specific order in order to improve the flexibility of location measurement. For example, the UE may request location assistance data at any time to perform the location measurement request already requested by the LMF. In addition, if the location information delivered by the UE does not satisfy the QoS required, the LMF may also request location information, such as location measurements or location estimates, at any time. Similarly, when the UE does not perform measurement for location estimation, the UE may transmit capability information to the LMF at any time.

In addition, when an Error occurs in the information or request exchanged between the LMF and the UE in step 3b, an Error message may be transmitted/received, and an Abort message may be transmitted/received for stopping position measurement.

On the other hand, the protocol used in step 3b may be an LPP protocol, which will be described later.

Meanwhile, step 3b may be additionally performed after step 3a is performed, or may be performed instead of step 3a.

In step 4, the LMF may provide a location service response to the AMF. In addition, the location service response may include information on whether the location estimation of the UE was successful and the location estimate of the UE. After that, if the procedure of FIG. 9 is initiated by step 1a, the AMF may deliver a location service response to a 5GC entity such as GMLC, and if the procedure of FIG. 9 is initiated by step 1b, the AMF may use a location service response to provide a location service related to an emergency call or the like.

In the protocol for location measurement described below, definitions of some terms may be based on Table 8 below.

```
TABLE 8
  NR-Uu interface: The NR-Uu interface, connecting the UE to the gNB over the air, is used
as one of several transport links for the LTE Positioning Protocol for a target UE with NR
access to NG-RAN.
    LTE-Uu interface: The LTE-Uu interface, connecting the UE to the ng-eNB over the air,
is used as one of several transport links for the LTE Positioning Protocol for a target UE
with LTE access to NG-RAN.
    NG-C interface: The NG-C interface between the gNB and the AMF and between the ng-
eNB and the AMF is transparent to all UE-positioning-related procedures. It is involved in
these procedures only as a transport link for the LTE Positioning Protocol. For gNB related
positioning procedures, the NG-C interface transparently transports both positioning
requests from the LMF to the gNB and positioning results from the gNB to the LMF. For
ng-eNB related positioning procedures, the NG-C interface transparently transports both
positioning requests from the LMF to the ng-eNB and positioning results from the ng-eNB
to the LMF.
    NLs interface: The NLs interface, between the LMF and the AMF, is transparent to all
UE related, gNB related and ng-eNB related positioning procedures. It is used only as a
transport link for the LTE Positioning Protocols LPP and NRPPa.
```

### LTE Positioning Protocol (LPP)

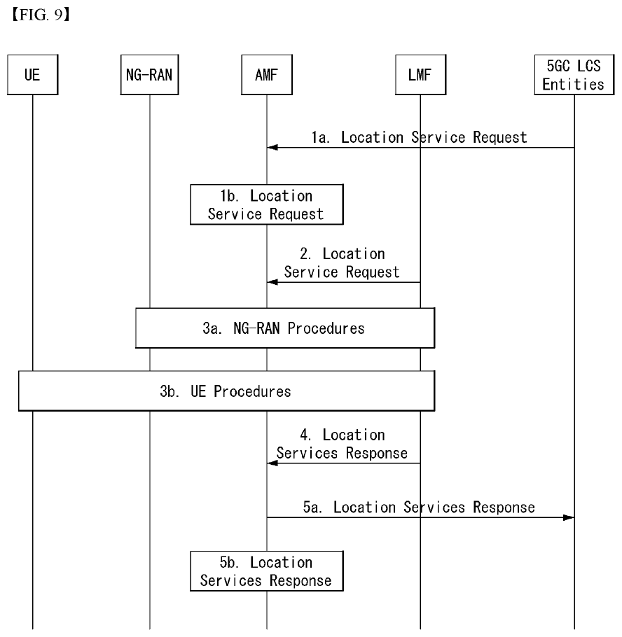

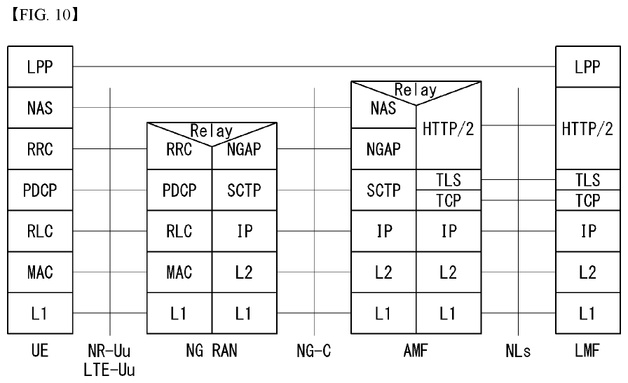

FIG. 10 is a diagram illustrating an example of a protocol layer for supporting LPP message transmission.

Referring to FIG. 10, an LPP PDU may be transmitted through a NAS PDU between the MAF and the UE. The LPP may terminate a connection between a target device (e.g. UE in the control plane or SUPL Enabled Terminal (SET) in the user plane) and a location server (e.g. LMF in the control plane or SLP in the user plane). The LPP message may be delivered in the form of a transparent PDU through an intermediate network interface using an appropriate protocol such as NGAP through the NG-C interface, NAS/RRC through the LTE-Uu and NR-Uu interfaces. The LPP protocol enables positioning for NR and LTE based on various positioning methods.

For example, the target device and the location server may exchange capability information, assistance data for positioning, and/or location information with each other through the LPP protocol. In addition, error information exchange and/or an instruction to stop the LPP procedure may be performed through the LPP message.

### LPP Procedures for UE Positioning

A signal transmission/reception operation based on the LPP protocol to which the method proposed in the present disclosure can be applied may be performed based on Table 9 below.

TABLE 9
As described above, the protocol operates between a “target” and a “server”. In the control-
plane context, these entities are the UE and LMF respectively; in the SUPL context they are
the SET and the SLP. A procedure may be initiated by either the target or the server.
1) Capability Transfer
Capabilities in an LPP context refer to the ability of a target or server to support different
position methods defined for LPP, different aspects of a particular position method (e.g.
different types of assistance data for A-GNSS) and common features not specific to only one
position method (e.g. ability to handle multiple LPP transactions). These capabilities are
defined within the LPP protocol and transferred between the target and the server using LPP
transport.
The exchange of capabilities between a target and a server may be initiated by a request or
sent as “unsolicited” information. If a request is used, the server sends an LPP Request
Capabilities message to the target device with a request for capability information. The target
sends an LPP Provide Capabilities message.
Example of LPP Capability Transfer procedure
1. The server may send a request for the LPP related capabilities of the target.
2. The target transfers its LPP-related capabilities to the server. The capabilities may refer to
particular position methods or may be common to multiple position methods.
LPP Capability Indication procedure is used for unsolicited capability transfer.
2) Assistance data Transfer
Assistance data may be transferred either by request or unsolicited. In this version of the
specification, assistance data delivery is supported only via unicast transport from server to
target.
Example of LPP Assistance Data Transfer procedure
1. The target may send a request to the server for assistance data and may indicate the
particular assistance data needed.
2. The server transfers assistance data to the target. The transferred assistance data should
match any assistance data requested in step 1.
3. Optionally, the server may transfer additional assistance data to the target in one or more
additional LPP messages.
LPP Assistance Data Delivery procedure is used for unilateral assistance data transfer. This
procedure is unidirectional; assistance data are always delivered from the server to the target.
3) Location Information Transfer
The term “location information” applies both to an actual position estimate and to values used
in computing position (e.g., radio measurements or positioning measurements). It is delivered
either in response to a request or unsolicited.
Example of LPP Location Information Transfer procedure
1. The server may send a request for location information to the target, and may indicate the
type of location information needed and associated QoS.
2. In response to step 1, the target transfers location information to the server. The location
information transferred should match the location information requested in step 1.
3. Optionally (e.g., if requested in step 1), the target in step 2 may transfer additional location
information to the server in one or more additional LPP messages.
LPP Location Information Delivery procedure is used for unilateral location information
transfer.
Furthermore, the LPP Location Information Delivery procedure can only be piggybacked in
the MO-LR request.
4) Multiple Transactions
Multiple LPP transactions may be in progress simultaneously between the same target and
server nodes, to improve flexibility and efficiency. However, no more than one LPP
procedure between a particular pair of target and server nodes to obtain location information
shall be in progress at any time for the same position method.
In this example, the objective is to request location measurements from the target, and the
server does not provide assistance data in advance, leaving the target to request any needed
assistance data.
Example of multiple LPP procedures
1. The server sends a request to the target for positioning measurements.
2. The target sends a request for particular assistance data.
3. The server returns the assistance data requested in step 2.
4. The target obtains and returns the location information (e.g., positioning method
measurements) requested in step 1.
5) Error handling
The procedure is used to notify the sending endpoint by the receiving endpoint that the
receiving LPP message is erroneous or unexpected. This procedure is bidirectional at the LPP
level; either the target or the server may take the role of either endpoint in the corresponding
procedure.
Example of Error handling procedure
1. The target or server sends a LPP message to the other endpoint (i.e, “Server/Target”).
2. If the server or target (“Server/Target”) detects that the receiving LPP message is
erroneous or unexpected, the server or target transfers error indication information to the
other endpoint (“Target/Server”).
6) Abort
The procedure is used to notify the other endpoint by one endpoint to abort an ongoing
procedure between the two endpoints. This procedure is bidirectional at the LPP level; either
the target or the server may take the role of either endpoint in the corresponding procedure.
Example of Abort procedure
1. A LPP procedure is ongoing between target and server.
2. If the server or target (“Server/Target”) determines that the procedure must be aborted, and
then the server or target sends an LPP Abort message to the other endpoint (“Target/Server”)
carrying the transaction ID for the procedure.

### NR Positioning Protocol A (NRPPa)

FIG. 11 is a diagram illustrating an example of a protocol layer for supporting NRPPa transmission. Specifically, FIG. 11 illustrates a protocol layer for supporting transmission of an NRPPa PDU (NR Positioning Protocol a Protocol Data Unit).

The NRPPa may be used for information exchange between the NG-RAN node and the LMF. Specifically, the NRPPa may used to exchange E-CID for measurement transmitted from ng-eNB to LMF, data for supporting the OTDOA positioning method, Cell-ID and Cell location ID for the NR Cell ID positioning method, and the like. The AMF may route NRPPa PDUs based on the routing ID of the associated LMF through the NG-C interface even if there is no information on the associated NRPPa transaction.

The procedure of the NRPPa protocol for location and data collection can be divided into two types. The first type is a UE associated procedure for delivering information on a specific UE (e.g. location measurement information, etc.), and the second type is a non-UE associated procedure for delivering information applicable to an NG-RAN node and related

TPs (e.g. gNB/ng-eNG/TP timing information, etc.). The two types of procedures may be supported independently or at the same time.

### NRPPa Procedure

A signal transmission/reception operation based on the NRPPa protocol to which the embodiments proposed in the present disclosure can be applied may be performed based on Table 10 below.

```
TABLE 10
Positioning and data acquisition transactions between a LMF and NG-RAN node are
modelled by using procedures of the NRPPa protocol. There are two types of NRPPa
procedures:
  UE associated procedure, i.e. transfer of information for a particular UE (e.g.
positioning measurements);
  Non UE associated procedure, i.e. transfer of information applicable to the NG-RAN
node and associated TPs (e.g. gNB/ng-eNB/TP timing information).
Parallel transactions between the same LMF and NG-RAN node are supported; i.e. a pair of
LMF and NG-RAN node may have more than one instance of an NRPPa procedure in
execution at the same time.
For possible extensibility, the protocol is considered to operate between a generic “access
node” (e.g. ng-eNB) and a “server” (e.g. LMF). A procedure is only initiated by the server.
Example of a single NRPPa transaction
1. Access Node sends NRPPa Procedure Request to Server.
2. Server sends NRPPa Procedure Response to Acces Node.
N. Access Node sends NRPPa Procedure Response (end transaction) to Server. (this step may
be omitted).
The exmaple shows a single NRPPa transaction. The transaction is terminated in step 2 in
the case of a non UE associated procedure. For a UE associated procedure to gather
information concerning the access node, additional responses may be allowed (e.g. sending
of updated information periodically and/or whenever there is some significant change). In
this case, the transaction may be ended after some additional responses. In the NRPPa
protocol, the described transaction may be realized by the execution of one procedure defined
as a request and a response, followed by one or several procedures initiated by the NG-RAN
node (each procedure defined as a single message) to realize the additional responses.
An example of LPPa transaction type may be “Location Information Transfer”. The term
“location information” applies both to an actual position estimate and to values used in
computing position (e.g., radio measurements or positioning measurements). It is delivered
in response to a request.
Example of Location information transfer
1. The server sends a request for location related information to the NG-RAN node,
and indicates the type of location information needed and associated QoS. The request may
refer to a particular UE.
2. In response to step 1, the NG-RAN Node transfers location related information to
the server. The location related information transferred should match the location related
information requested in step 1.
3. If requested in step 1, the NG-RAN node may transfer additional location related
information to the server in one or more additional NRPPa messages when the positioning
method is E-CID for E-UTRA.
```

In the present disclosure, a message exchanged (transmitted and received) between a UE (a target device)/location server for positioning and a configuration related to the message may be based on Table 11 below.

### Positioning Measurement Method

The positioning measurement methods supported by NG-RAN may include GNSS, OTDOA, E-CID (enhanced cell ID), Multi RTT (round trip time)/Multi-cell RTT, barometric pressure sensor positioning, WLAN positioning, Bluetooth positioning, and TBS (terrestrial beacon system), UTDOA (Uplink Time Difference of Arrival), etc. Among the positioning measurement methods, any one positioning measurement method may be used to measure the location of the UE, but two or more positioning measurement methods may be used to measure the location of the UE.

In the positioning measurement method described below, definitions of some terms may be based on Table 12 below.

TABLE 12
5.1.13 Reference signal time difference (RSTD) for E-UTRA

| | |
|---|---|
| Definition | The relative timing difference between the E-UTRA neighbour cell j |
| | and the E-UTRA reference cell i, defined as TSubframeRxj- |
| | TSubframeRxi, where: TSubframeRxj is the time when the UE receives |
| | the start of one subframe from E-UTRA cell j TSubframeRxi is the time |
| | when the UE receives the corresponding start of one subframe from E- |
| | UTRA cell i that is closest in time to the subframe received from E- |
| | UTRA cell j. The reference point for the observed subframe time |
| | difference shall be the antenna connector of the UE. |
| Applicable for | RRC_CONNECTED inter-RAT |

5.1.28 DL PRS reference signal received power (DL PRS-RSRP)

| | |
|---|---|
| Definition | DL PRS reference |
| | signal received power (DL PRS-RSRP), is defined as |
| | the linear average over the power contributions (in [W]) of the resource |
| | elements that carry DL PRS reference signals configured for RSRP |
| | measurements within the considered measurement frequency bandwidth. |
| | For frequency range 1, the reference point for the DL PRS-RSRP shall be |
| | the antenna connector of the UE. For frequency range 2, DL PRS-RSRP |
| | shall be measured based on the combined signal from antenna elements |
| | corresponding to a given receiver branch. For frequency range 1 and 2, if |
| | receiver diversity is in use by the UE, the reported DL PRS-RSRP value |
| | shall not be lower than the corresponding DL PRS-RSRP of any of the |
| | individual receiver branches. |
| Applicable for | RRC_CONNECTED intra-frequency, |
| | RRC_CONNECTED inter-frequency |

5.1.29 DL relative signal time difference (DL RSTD)

| | |
|---|---|
| Definition | DL relative timing difference (DL RSTD) between the positioning node j |
| | and the reference positioning node i, is defined as TSubframeRxj- |
| | TSubframeRxi, |
| | Where: |
| | TSubframeRxj is the time when the UE receives the start of one subframe |
| | from positioning node j. |
| | TSubframeRxi is the time when the UE receives the corresponding start of |
| | one subframe from positioning node i that is closest in time to the subframe |
| | received from positioning node j. |
| | Multiple DL PRS resources can be used to determine the start of one |
| | subframe from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable for | RRC_CONNECTED intra-frequency |
| | RRC_CONNECTED inter-frequency |

5.1.29 DL reference signal time difference (DL RSTD)

| | |
|---|---|
| Definition | DL reference signal time difference (DL RSTD) is the DL relative timing |
| | difference between the positioning node j and the reference positioning node |
| | i, defined as TSubframeRxj-TSubframeRxi, |
| | Where: |
| | TSubframeRxj is the time when the UE receives the start of one subframe |
| | from positioning node j. |
| | TSubframeRxi is the time when the UE receives the corresponding start off |
| | one subframe from positioning node i that is closest in time to the subframe |
| | received from positioning node j. |
| | Multiple DL PRS resources can be used to determine the start of one |
| | subframe from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable for | RRC_CONNECTED intra-frequency |
| | RRC_CONNECTED inter-frequency |

5.1.30 UE Rx-Tx time difference

| | |
|---|---|
| Definition | The UE Rx-Tx time difference is defined as TUE-RX-TUE-TX |
| | Where: |
| | TUE-RX is the UE received timing of downlink subframe #i from a |
| | positioning node, defined by the first detected path in time. |
| | TUE-TX is the UE transmit timing of uplink subframe #j that is closest in |
| | time to the subframe #i received from the positioning node. |
| | Multiple DL PRS resources can be used to determine the start of one |
| | subframe of the first arrival path of the positioning node. |
| | For frequency range 1, the reference point for TUE-RX measurement shall |
| | be the Rx antenna connector of the UE and the reference point for TUE-TX |
| | measurement shall be the Tx antenna connector of the UE. For frequency |
| | range 2, the reference point for TUE-RX measurement shall be the Rx |
| | antenna of the UE and the reference point for TUE-TX measurement shall |
| | be the Tx antenna of the UE. |
| Applicable for | RRC_CONNECTED intra-frequency |
| | RRC_CONNECTED inter-frequency |

5.2.2 UL Relative Time of Arrival (TUL-RTOA)

| | |
|---|---|
| Definition | [The UL Relative Time of Arrival (TUL-RTOA) is the beginning of |
| | subframe i containing SRS received in positioning node j, relative to the |
| | configurable reference time.] |
| | Multiple SRS resources for positioning can be used to determine the |
| | beginning of one subframe containing SRS received at a positioning node. |
| | The reference point for TUL-RTOA shall be: |
| | for type 1-C base station TS 38.104 [9]: the Rx antenna connector, |
| | for type 1-O or 2-O base station TS 38.104 [9]: the Rx antenna, |
| | for type 1-H base station TS 38.104 [9]: the Rx Transceiver Array |
| | Boundary connector. |

5.2.3 gNB Rx-Tx time difference

| | |
|---|---|
| Definition | The gNB Rx-Tx time difference is defined as TgNB-RX-TgNB-TX |
| | Where: |
| | TgNB-RX is the positioning node received timing of uplink subframe #i |
| | containing SRS associated with UE, defined by the first detected path in |
| | time. |
| | TgNB-TX is the positioning node transmit timing of downlink subframe #j |
| | that is closest in time to the subframe #i received from the UE. |
| | Multiple SRS resources for positioning can be used to determine the start |
| | of one subframe containing SRS. |
| | The reference point for TgNB-RX shall be: |
| | for type 1-C base station TS 38.104 [9]: the Rx antenna connector, |
| | for type 1-O or 2-O base station TS 38.104 [9]: the Rx antenna, |
| | for type 1-H base station TS 38.104 [9]: the Rx Transceiver Array |
| | Boundary connector. |
| | The reference point for TgNB-TX shall be: |
| | for type 1-C base station TS 38.104 [9]: the Tx antenna connector, |
| | for type 1-O or 2-O base station TS 38.104 [9]: the Tx antenna, |
| | for type 1-H base station TS 38.104 [9]: the Tx Transceiver Array |
| | Boundary connector. |

5.2.4 UL Angle of Arrival (UL AoA)

| | |
|---|---|
| Definition | UL Angle of Arrival (UL AoA) is defined as the estimated azimuth angle |
| | and vertical angle of a UE with respect to a reference direction, wherein the |
| | reference direction is defined: |
| | In the global coordinate system (GCS), wherein estimated azimuth |
| | angle is measured relative to geographical North and is positive in a |
| | counter-clockwise direction and estimated vertical angle is measured |
| | relative to zenith and positive to horizontal direction |
| | In the local coordinate system (LCS), wherein estimated azimuth |
| | angle is measured relative to x-axis of LCS and positive in a counter- |
| | clockwise direction and estimated vertical angle is measured relatize to z- |
| | axis of LCS and positive to x-y plane direction. The bearing, downtilt and |
| | slant angles of LCS are defined according to TS 38.901 [14]. |
| | The UL AoA is determined at the gNB antenna for an UL channel |
| | corresponding to this UE. |

5.2.5 UL SRS reference signal received power (UL SRS-RSRP)

| | |
|---|---|
| Definition | UL SRS reference signal received power (UL SRS-RSRP) is defined as |
| | linear average of the power contributions (in [W]) of the resource elements |
| | carrying sounding reference signals (SRS). UL SRS-RSRP shall be |
| | measured over the configured resource elements within the considered |
| | measurement frequency bandwidth in the configured measurement time |
| | occasions. |
| | For frequency range 1, the reference point for the UL SRS-RSRP shall be |
| | the antenna connector of the gNB. For frequency range 2, UL SRS-RSRP |
| | shall be measured based on the combined signal from antenna elements |
| | corresponding to a given receiver branch. For frequency range 1 and 2, if |
| | receiver diversity is in use by the gNB, the reported UL SRS-RSRP value |
| | shall not be lower than the corresponding UL SRS-RSRP of any of the |
| | individual receiver branches. |

### OTDOA (Observed Time Difference of Arrival)

FIG. 12 is a diagram illustrating an example of an OTDOA positioning measurement method.

In the OTDOA positioning measurement method uses the measurement timing of downlink signals received by the UE from multiple TPs including an eNB, an ng-eNB, and a PRS-only TP. The UE measures the timing of the received downlink signals by using the location assistance data received from the location server. In addition, the location of the UE may be determined based on these measurement results and the geographic coordinates of the contiguous TPs.

A UE connected to the gNB may request a measurement gap for OTDOA measurement from the TP. If the UE does not recognize the SFN for at least one TP in the OTDOA assistance data, the UE may use the autonomous gap to obtain the SFN of the OTDOA reference cell before requesting the measurement gap for performing Reference Signal Time Difference (RSTD) measurement.

Here, the RSTD may be defined based on the smallest relative time difference between the boundaries of two subframes respectively received from the reference cell and the measurement cell. That is, it may be calculated based on the relative time difference between the start times of the subframes of the reference cell closest to the start time of the subframe received from the measurement cell. Meanwhile, the reference cell may be selected by the UE.

For accurate OTDOA measurement, it is necessary to measure the time of arrival (TOA) of a signal received from three or more geographically dispersed TPs or base stations. For example, the TOA for each of TP 1, TP 2 and TP 3 may be measured, the RSTD for TP 1-TP 2, the RSTD for TP 2-TP 3, and the RSTD for TP 3-TP 1 may be calculated based on the three TOAs, a geometric hyperbola may be determined based on this, and a point where these hyperbola intersects may be estimated as the location of the UE. In this case, since accuracy and/or uncertainty for each TOA measurement may occur, the estimated location of the UE may be known as a specific range depending on the measurement uncertainty.

For example, RSTDs for two TPs may be calculated based on Equation 3 below.

$${RSTD}_{i , 1} = \frac{\sqrt{{( {x}_{t} - {x}_{i} )}^{2} + {( {y}_{t} - {y}_{i} )}^{2}}}{c} - \frac{\sqrt{{( {x}_{t} - {x}_{1} )}^{2} + {( {y}_{t} - {y}_{1} )}^{2}}}{c} + ( {T}_{i} - {T}_{1} ) + ( {n}_{i} - {n}_{1} ) \qquad [ Equation 3 ]$$

Here, c may be the speed of light, {xt, yt} may be the (unknown) coordinates of the target UE, {xi, yi} may be the coordinates of the (known) TP, and {25, y1} may be the coordinates of the reference TP (or other TP). Here, (Ti−T1) is a transmission time offset between two TPs, which may be referred to as “Real Time Differences” (RTDs), and ni and nl may represent values related to UE TOA measurement errors.

### E-CID (Enhanced Cell ID)

In the cell ID (CID) positioning measurement method, the location of the UE may be measured through geographic information of the serving ng-eNB, the serving gNB and/or the serving cell of the UE. For example, geographic information of the serving ng-eNB, the serving gNB, and/or the serving cell may be obtained through paging, registration, or the like.

Meanwhile, the E-CID positioning measurement method may use additional UE measurement and/or NG-RAN radio resources and the like for improving the UE location estimate in addition to the CID positioning measurement method. In the E-CID positioning measurement method, some of the same measurement methods as those of the measurement control system of the RRC protocol may be used, but in general, additional measurement is not performed only for the location measurement of the UE. In other words, a separate measurement configuration or measurement control message may not be provided to measure the location of the UE, and the UE also does not expect that an additional measurement operation only for location measurement will be requested, and the UE may report a measurement value obtained through generally measurable measurement methods.

For example, the serving gNB may implement the E-CID positioning measurement method using the E-UTRA measurement provided from the UE.

An example of a measurement element that can be used for E-CID positioning may be as follows.
UE measurement: E-UTRA RSRP (Reference Signal Received Power), E-UTRA RSRQ (Reference Signal Received Quality), UE E-UTRA reception-transmission time difference (Rx-Tx Time difference), GERAN/WLAN RSSI (Reference Signal Strength Indication), UTRAN CPICH (Common Pilot Channel) RSCP (Received Signal Code Power), UTRAN CPICH Ec/Io
E-UTRAN measurement: ng-eNB reception-transmission time difference (Rx-Tx Time difference), timing advance (Timing Advance: TADV), Angle of Arrival (AoA)

Here, TADV may be divided into Type 1 and Type 2 as follows.

TADV Type 1=(ng-eNB reception-transmission time difference)+(UE E-UTRA reception-transmission time difference)

TADV Type 2=ng-eNB reception-transmission time difference

On the other hand, AoA may be used to measure the direction of the UE. AoA may be defined as an estimated angle for the location of the UE in a counterclockwise direction from the base station/TP. In this case, the geographic reference direction may be north. The base station/TP may use an uplink signal such as a sounding reference signal (SRS) and/or a demodulation reference signal (DMRS) for AoA measurement. In addition, the larger the antenna array arrangement, the higher the AoA measurement accuracy, when the antenna arrays are arranged at the same interval, signals received from contiguous antenna elements may have a constant phase-rotate.

### UTDOA (Uplink Time Difference of Arrival)

UTDOA is a method of determining the location of the UE by estimating the arrival time of the SRS. When calculating the estimated SRS arrival time, the location of the UE may be estimated through the difference in arrival time with another cell (or base station/TP) by using the serving cell as a reference cell. To implement UTDOA, the E-SMLC may instruct the serving cell of the target UE to instruct the target UE to transmit SRS. In addition, the E-SMLC may provide configuration such as whether the SRS is periodic/aperiodic, bandwidth, and frequency/group/sequence hopping, etc.

### Multi RTT (Multi-Cell RTT)

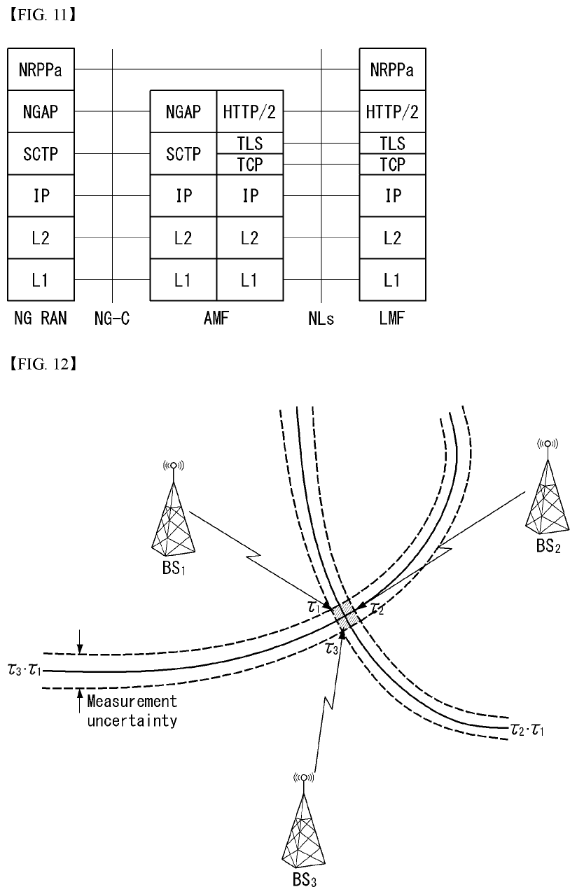

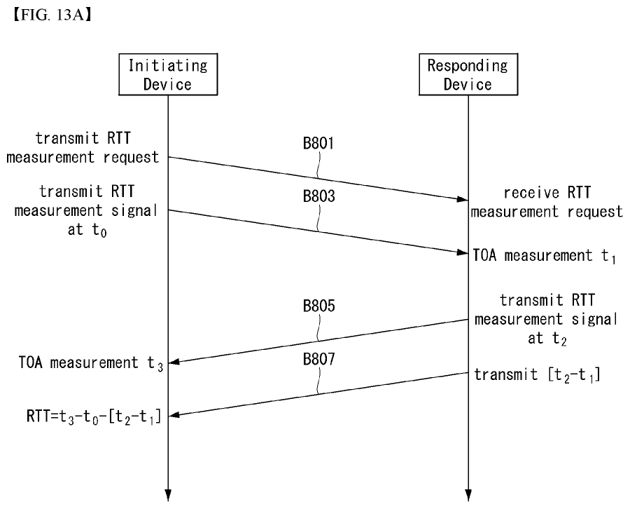

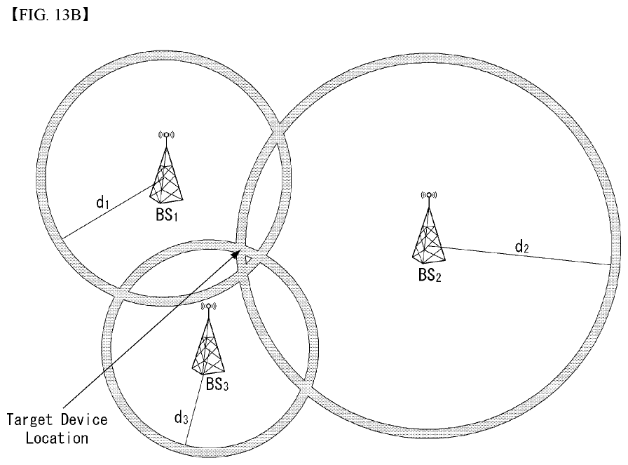

Unlike OTDOA, which requires fine synchronization (e.g. nano-second level) between TPs in the network, RTT is based on TOA measurement like the OTDOA, but requires only coarse TRP (e.g. base station) timing synchronization. Hereinafter, it will be described in detail with reference to FIGS. 13A and 13B.

FIGS. 13A and 13B are diagrams illustrating an example of a Multi RTT positioning measurement method.

Referring to FIG. 13A, an RTT process, in which TOA measurement is performed in an initiating device and a responding device, and the responding device provides the TOA measurement to the initiating device for RTT measurement (calculation), is exemplified. For example, the initiating device may be a TRP and/or a UE, and the responding device may be the UE and/or the TRP.

In operation B801 based on an exemplary embodiment, the initiating device may transmit an RTT measurement request, and the responding device may receive it.

In operation B803 based on an exemplary embodiment, the initiating device may transmit an RTT measurement signal at t0, and the responding device may acquire a TOA measurement t1.

In operation B805 based on an exemplary embodiment, the responding device may transmit the RTT measurement signal at t2, and the initiating device may acquire a TOA measurement t3.

In operation B807 based on an exemplary embodiment, the responding device may transmit information on [t2−t1], and the initiating device may receive the corresponding information and calculate the RTT based on Equation 4 below. The corresponding information may be transmitted/received based on a separate signal, or may be transmitted/received by being included in the RTT measurement signal of B805.

$$RTT = {t}_{3} - {t}_{0} - [ {t}_{2} - {t}_{1} ] \qquad [ Equation 4 ]$$

Referring to FIG. 13B, the corresponding RTT may correspond to double-range measurement between two devices. Positioning estimation may be performed from the corresponding information, and a multilateration technique may be used. Based on the measured RTT, d1, d2, and d3 may be determined, and the target device location may be determined by the intersection of the circumference with each BS1, BS2, BS3 (or TRP) as a center and each d1, d2, and d3 as a radius.

### Sounding Procedure for Positioning Purpose

The sounding procedure for positioning the UE in the NR system to which various embodiments of the present disclosure are applicable can be based on Table 13 below.

TABLE 13
6.2.1.4 UE sounding procedure for positioning purposes
When the SRS is configured by the higher layer parameter [SRS-for-positioning] and if the
higher layer parameter spatialRelationInfo is configured, it contains the ID of the
configuration fields of a reference RS according to Clause 6.3.2 of [TS 38.331]. The
reference RS can be an SRS configured by the higher layer parameter SRS-Config or [SRS-
for-positioning], CSI-RS, SS/PBCH block, or a DL PRS configured on a serving cell or a
SS/PBCH block or a DL PRS configured on a non-serving cell.
The UE is not expected to transmit multiple SRS resources with different spatial relations
in the same
OFDM symbol.
If the UE is not configured with the higher layer parameter spatialRelationInfo the UE may
use a fixed spatial domain transmission filter for transmissions of the SRS configured by
the higher layer parameter [SRS-for-positioning] across multiple SRS resources or it may
use a different spatial domain transmission filter across multiple SRS resources.
The UE is only expected to transmit an SRS configured the by the higher layer parameter
[SRS-for-positioning] within the active UL BWP of the UE.
When the configuration of SRS is done by the higher layer parameter [SRS-for-
positioning], the UE can only be provided with a single RS source in spatialRelationInfo
per SRS resource.
If an SRS configured by the higher parameter [SRS-for-positioning] collides with a
scheduled PUSCH, the SRS is dropped in the symbols where the collision occurs.

### Triggering Sounding Procedure for Positioning Purpose

For example, the sounding procedure may be triggered by the SRS request field included in DCI format 0_1. More specific DCI format configuration can be based on Table 14 below:

```
TABLE 14
7.3.1.1.2  Format 0 1
DCI format 0_1 is used for the scheduling of one or multiple PUSCH in one cell, or
indicating CG downlink feedback informatin (CG-DFI) to a UE.
If DCI format 0_1 is used for the scheduling of one or multiple PUSCH in one cell or
activating type 2 CG transmission, all the remaining fileds are set as follows:
  SRS request-2 bits as defined by Table 7.3.1.1.2-24 for UEs not configured with
  supplementaryUplink in ServingCellConfig in the cell; 3 bits for UEs configured with
  supplementaryUplink in ServingCellConfig in the cell where the first bit is the non-
  SUL/SUL indicator as defined in Table 7.3.1.1.1-1 [TS 38.212] and the second and
  third bits are defined by Table 7.3.1.1.2-24. This bit field may also indicate the
  associated CSI-RS according to Clause 6.1.1.2 of [6, TS 38.214].
Table 7.3.1.1.2-24: SRS request
```

| | Triggered aperiodic SRS | |
|---|---|---|
| | resource set(s) for DCI format | |
| Value | 0_1, 0_2, 1_1, 1_2, and 2_3 | Triggered aperiodic SRS resource set(s) |
| of SRS | configured with higher layer | for DCI format 2_3 configured with |
| request | parameter srs-TPC-PDCCH- | higher layer parameter srs-TPC- |
| field | Group set to ‘typeB’ | PDCCH-Group set to ‘typeA’ |
| 00 | No aperiodic SRS resource set | No aperiodic SRS resource set triggered |
| | triggered | |
| 01 | SRS resource set(s) configured | SRS resource set(s) configured with |
| | with higher layer parameter | higher layer parameter usage in SRS- |
| | aperiodicSRS-ResourceTrigger | ResourceSet set to 'antennaSwitching' and |
| | set to 1 or an entry in | resourceType in SRS-ResourceSet set to |
| | aperiodicSRS- | ‘aperiodic’ for a 1^{st} set of serving cells |
| | ResourceTriggerList set to 1 | configured by higher |
| | | layers, or |
| | | SRS resource set(s) configured by [SRS- |
| | | ResourceSetForPositioning] and |
| | | resourceType in [SRS- |
| | | ResourceSetForPositioning] set to |
| | | ‘aperiodic’ for a 1^{st} set of serving cells |
| | | configured by higher layers |
| 10 | SRS resource set(s) configured | SRS resource set(s) configured with |
| | with higher layer parameter | higher layer parameter usage in SRS- |
| | aperiodicSRS-ResourceTrigger | ResourceSet set to ‘antennaSwitching’ and |
| | set to 2 or an entry in | resourceType in SRS-ResourceSet set to |
| | aperiodicSRS- | ‘aperiodic’ for a 2^{nd} set of serving cells |
| | ResourceTriggerList set to 2 | configured by higher layers, or |
| | | SRS resource set(s) configured by [SRS- |
| | | ResourceSetForPositioning] and |
| | | resourceType in [SRS- |
| | | ResourceSetForPositioning/ set to |
| | | ‘aperiodic’ for a 2^{nd} set of serving cells |
| | | configured by higher layers |
| 11 | SRS resource set(s) configured | SRS resource set(s) configured with |
| | with higher layer parameter | higher layer parameter usage in SRS- |
| | | ResourceSet |
| | aperiodicSRS-ResourceTrigger | set to ‘antennaSwitching’ and resourceType |
| | set to 3 or an entry in | in SRS-ResourceSet set to ‘aperiodic’ for a |
| | aperiodicSRS- | 3^{rd} set of serving cells configured by |
| | ResourceTriggerList set to 3 | higher layers, or |
| | | SRS resource set(s) configured by [SRS- |
| | | ResourceSetForPositioning/and |
| | | resourceType in [SRS- |
| | | ResourceSetForPositioning/set to |
| | | ‘aperiodic’ for a 3^{rd} set of serving cells |
| | | configured by higher layers |

### Mapping SRS of Sounding Procedure for Positioning Purpose

In the NR system to which various embodiments of the present disclosure are applicable. PRS mapping may be based on Table 15 below.

TABLE 15
6.4.1.4 Sounding reference signal
6.4.1.4.1 SRS resource
An SRS resource is configured by the SRS-Resource IE or the [SRS-for-positioning] IE
6.4.1.4.2 Sequence generation
The sounding reference signal sequence for an SRS resource shall be generated according
to
r^{(p}^{ᵢ}⁾ (n, l′) = r_{u,v}^{(α}^{ᵢ}^{,δ)}(n)
0 ≤ n ≤ M_{sc,b}^{SRS} − 1
l′ ∈ {0, 1, . . . , N_{symb}^{SRS} − 1}
where M_{sc,b}^{SRS} is given by clause 6.4.1.4.3, r_{u,v}^{(α,δ)} (n) is given by clause 5.2.2 with δ =
log₂ (K_{TC}) and the transmission comb number K_{TC} ∈ {2, 4, 8} is contained in the higher-layer
parameter transmissionComb. The cyclic shift αᵢ for antenna port pᵢ is given as
${α}_{i} = 2 π \frac{{n}_{SRS}^{cs , i}}{{n}_{SRS}^{cs , max}}$ ${n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max} ,$
where n_{SRS}^{cs} ∈ {0, 1, . . . , n_{SRS}^{cs,max} − 1} is contained in the higher layer parameter transmissionComb. The
maximum number of cyclic shifts n_{SRS}^{cs,max} are given by Table 6.4.1.4.2-1.
The sequence group u = (f_{gh} (n_{s,f}^{μ}, l′) + n_{ID}^{SRS}) mod 30 and the sequence number, in clause
5.2.2 [TS 38.211] depends on the higher-layer parameter groupOrSequenceHopping in the
SRS-Config IE or the [SRS-for-positioning] IE. The SRS sequence identity ns_{ID}^{SRS} is given by
the higher layer parameter sequenceId in the SRS-Config IE, in which case n_{ID}^{SRS} ∈
{0, 1, . . . , 1023}, or the [SRS-for-positioning] IE, in which case n_{ID}^{SRS} ∈ {0, 1, . . . , 65535}.
The quantity l′ ∈ {0, 1, . . . , N_{symb}^{SRS} − 1} is the OFDM symbol number within the SRS
resource.
Table 6.4.1.4.2-1: Maximum number of cyclic shifts n_{SRS}^{cs,max} as function of K_{TC}.

| K_{TC} | N_{SRS}^{cs,max} |
|---|---|
| 2 | 8 |
| 4 | 12 |
| 8 | 6 |

6.4.1.4.3 Mapping to physical resources
When SRS is transmitted on a given SRS resource, the sequence r^{(P}^{ᵢ}⁾ (n, l′) for each
OFDM symbol l and for each of the antenna ports of the SRS resource shall be multiplied
with the amplitude scaling factor β_{SRS} in order to conform to the transmit power specified
in [5, 38.213] and mapped in sequence starting with r^{(p}^{ᵢ}⁾(0, l′) to resource elements (k, l) in a
slot for each of the antenna ports pᵢ according to
${a}_{{K}_{TC} {k}^{′} + {k}_{0}^{( {p}_{i} )} , {l}^{′} + {l}_{0}}^{( {p}_{i} )} = \{ \begin{matrix}\frac{1}{\sqrt{{N}_{ap}}} {β}_{SRS} {r}^{( {p}_{i} )} ( {k}^{′} , {l}^{′} ) & {k}^{′} = 0 , 1 , … , {M}_{sc , b}^{SRS} - 1 {l}^{′} = 0 , 1 , … , {N}_{symb}^{SRS} - 1 \\ 0 & otherwise\end{matrix}$
The length of the sounding reference signal sequence is given by
M_{sc,b}^{SRS} = m_{SRS,b}N_{sc}^{RB}/K_{TC}
where m_{SRS,b} is given by a selected row of Table 6.4.1.4.3-1 [TS 38.211] with b = B_{SRS} where
B_{SRS} ∈ {0,1,2,3} is given by the field b-SRS contained in the higher-layer parameter
freqHopping if configured, otherwise B_{SRS} = 0. The row of the table is selected according
to the index C_{SRS} ∈ {0, 1, . . . ,63} given by the field c-SRS contained in the higher-layer
parameter freqHopping.
The frequency-domain starting position k₀^{(p}^{ᵢ}⁾ is defined by
${k}_{0}^{( {p}_{i} )} = {\overline{k}}_{0}^{( {p}_{i} )} + {\sum }_{b = 0}^{{B}_{SRS}} {K}_{TC} {M}_{sc , b}^{SRS} {n}_{b}$
where
${\overline{k}}_{0}^{( {p}_{i} )} = {n}_{shift} {N}_{sc}^{RB} + ( {k}_{TC}^{( {p}_{i} )} + {k}_{offset}^{{l}^{′}} ) mod {K}_{TC}$ ${k}_{TC}^{( {p}_{i} )} = \begin{matrix}( {\overline{k}}_{TC} + {K}_{TC} / 2 ) mod {K}_{TC} & if {n}_{SRS}^{cs} ∈ \{ {n}_{SRS}^{cs , max} / 2 , … , {n}_{SRS}^{cs , max} - 1 \} and {N}_{ap}^{SRS} = 4 and {p}_{i} ∈ \\ {\overline{k}}_{TC} & otherwise\end{matrix}$
If NBWp ≤ n_{shift} the reference point for k₀^{(p}^{ᵢ}⁾ = 0 is subcarrier 0 in common resource block
0, otherwise the reference point is the lowest subcarrier of the BWP.
If the SRS is configured by the IE [SRS-for-positioning], the quantity k_{offset}^{l′} is given by
Table 6.4.1.4.3-2, otherwise k_{offset}^{l′} = 0.
The frequency domain shift value n_{shift} adjusts the SRS allocation with respect to the
reference point grid and is contained in the higher-layer parameter freqDomainShift in the
SRS-Config IE or the [SRS-for-positioning] IE. The transmission comb offset k̅_{TC} ∈
{0, 1, . . . , K_{TC} − 1} is contained in the higher-layer parameter transmissionComb in the SRS-
Config IE or the [SRS-for-positioning] IE and n_{b} is a frequency position index.
Table 6.4.1.4.3-2: The offset k_{offset}^{l′} for SRS as a function of K_{TC} and l′.

| | k_{offset}⁰, . . . , k_{off}^{N}^{_{symb}}^{^{SRS}}⁻¹ | | | | |
|---|---|---|---|---|---|
| K_{TC} | N_{symb}^{SRS} = 1 | N_{symb}^{SRS} = 2 | N_{symb}^{SRS} = 4 | N_{symb}^{SRS} = 8 | N_{symb}^{SRS} = 12 |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, 0, 2, 1, 3 |
| 8 | — | | 0, 4, 2, 6 | 0, 4, 2, 6, 1, 5, 3, 7 | 0, 4, 2, 6, 1, 5, 3, 7, 0, 4, 2, 6 |

6.4.1.4.4 Sounding reference signal slot configuration
For an SRS resource configured as periodic or semi-persistent by the higher-layer
parameter resourceType, a periodicity T_{SRS} (in slots) and slot offset T_{offset} are configured
according to the higher-layer parameter periodicityAndOffset-p or periodicityAndOffset-sp
in the SRS-Config IE, or periodicityAndOffset in the [SRS-for-positioning] IE. Candidate
slots in which the configured SRS resource may be used for SRS transmission are the slots
satisfying
(Nₛₗₒₜ^{frame,μ} n_{f} + n_{s,f}^{μ} − T_{offset}) mod T_{SRS} = 0
SRS is transmitted as described in clause 11.1 of [5, TS 38.213].

### Paging

In the NR system to which various embodiments of the present disclosure are applicable, paging may be based on Table 16 below.

TABLE 16
(1) General

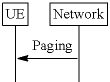

FIG. 5.3.2.1-1: Paging

The purpose of this procedure is:
to transmit paging information to a UE in RRC_IDLE or RRC_INACTIVE.
The network initiates the paging procedure by transmitting the Paging message at the UE' s
paging occasion as specified in TS 38.304 [20]. The network may address multiple UEs
within a Paging message by including one PagingRecord for each UE.
(2) Reception of the Paging message by the UE
Upon receiving the Paging message, the UE shall:
1>if in RRC IDLE, for each of the PagingRecord, if any, included in the Paging
message:
2>if the ue-Identity included in the PagingRecord matches the UE identity allocated
by upper layers:
3>forward the ue-Identity and access Type (if present) to the upper layers;
1>if in RRC INACTIVE, for each of the PagingRecord, if any, included in the Paging
message:
2>if the ue-Identity included in the PagingRecord matches the UE's stored fullI-
RNTI:
3>if the UE is configured by upper layers with Access Identity 1:
4>initiate the RRC connection resumption procedure according to 5.3.13 with
resumeCause set to mps-PriorityAccess;
3>else if the UE is configured by upper layers with Access Identity 2:
4>initiate the RRC connection resumption procedure according to 5.3.13 with
resumeCause set to mcs-PriorityAccess;
3>else if the UE is configured by upper layers with one or more Access Identities
equal to 11-15:
4>initiate the RRC connection resumption procedure according to 5.3.13 with
resumeCause set to highPriorityAccess;
3>else:
4>initiate the RRC connection resumption procedure according to 5.3.13 with
resumeCause set to mt-Access;
2>else if the ue-Identity included in the PagingRecord matches the UE identity
allocated by upper layers:
3>forward the ue-Identity to upper layers and accessType (if present) to the upper
layers;
3>perform the actions upon going to RRC_IDLE as specified in 5.3.11 with
release cause ‘other’.
(3) Discontinuous Reception for paging
The UE may use Discontinuous Reception (DRX) in RRC_IDLE and RRC_INACTIVE state
in order to reduce power consumption. The UE monitors one paging occasion (PO) per DRX
cycle. A PO is a set of PDCCH monitoring occasions and can consist of multiple time slots
(e.g. subframe or OFDM symbol) where paging DCI can be sent (TS 38.213 [4]). One Paging
Frame (PF) is one Radio Frame and may contain one or multiple PO(s) or starting point of
a PO.
In multi-
beam operations, the UE assumes that the same paging message and the same Short Message
are repeated in all transmitted beams and thus the selection of the beam(s) for the reception
of the paging message and Short Message is up to UE implementation. The paging message
is same for both RAN initiated paging and CN initiated paging.
The UE initiates RRC Connection Resume procedure upon receiving RAN initiated paging.
If the UE receives a CN initiated paging in RRC_INACTIVE state, the UE moves to
RRC_IDLE and informs NAS.
The PF and PO for paging are determined by the following formulae:
SFN for the PF is determined by:
(SFN + PF_offset) mod T = (T div N)*(UE_ID mod N)
Index (i_s), indicating the index of the PO is determined by:
i_s = floor (UE_ID/N) mod Ns
The PDCCH monitoring occasions for paging are determined according to
pagingSearchSpace as specified in TS 38.213 [4] and firstPDCCH-
MonitoringOccasionOfPO if configured as specified in TS 38.331 [3]. When SearchSpaceId =
0 is configured for pagingSearchSpace, the PDCCH monitoring occasions for paging are
same as for RMSI as defined in clause 13 in TS 38.213 [4].
When SearchSpaceId = 0 is configured for pagingSearchSpace, Ns is either 1 or 2. For Ns =
1, there is only one PO which starts from the first PDCCH monitoring occasion for paging in
the PF. For Ns = 2, PO is either in the first half frame (i_s = 0) or the second half frame (i_s =
1) of the PF.
When SearchSpaceId other than 0 is configured for pagingSearchSpace, the UE monitors the
(i_s + 1)^{th} PO. A PO is a set of ‘S’ consecutive PDCCH monitoring occasions where ‘S‘ is the
number of actual transmitted SSBs determined according to ssb-PositionsInBurst in SIB1.
The K^{th} PDCCH monitoring occasion for paging in the PO corresponds to the K^{th} transmitted
SSB. The PDCCH monitoring occasions for paging which do not overlap with UL symbols
(determined according to tdd-UL-DL-ConfigurationCommon) are sequentially numbered
from zero starting from the first PDCCH monitoring occasion for paging in the PF. When
firstPDCCH-MonitoringOccasionOfPO is present, the starting PDCCH monitoring occasion
number of (i_s + 1)^{th} PO is the (i_s + 1)^{th} value of the firstPDCCH-MonitoringOccasionOfPO
parameter; otherwise, it is equal to i_s * S.
NOTE 1:
A PO associated with a PF may start in the PF or after the PF.
NOTE 2:
The PDCCH monitoring occasions for a PO can span multiple radio
frames. When SearchSpaceId other than 0 is configured for paging-
SearchSpace the PDCCH monitoring occasions for a PO can span multiple
periods of the paging search space.
The following parameters are used for the calculation of PF and i_s above:
T: DRX cycle of the UE (T is determined by the shortest of the UE specific DRX
value(s), if configured by RRC and/or upper layers, and a default DRX value
broadcast in system
information. In RRC_IDLE state, if UE specific DRX is not configured by upper
layers, the default value is applied).
N: number of total paging frames in T
Ns: number of paging occasions for a PF
PF_offset: offset used for PF determination
UE_ID: 5G-S-TMSI mod 1024
Parameters Ns, nAndPagingFrameOffset, and the length of default DRX Cycle are signaled
in SIBI. The values of N and PF_offset are derived from the parameter
nAndPagingFrameOffset as defined in TS 38.331 [3]. The parameter first-PDCCH-
MonitoringOccasionOfPO is signalled in SIBI for paging in initial DL BWP. For paging in
a DL BWP other than the initial DL BWP, the parameter first-PDCCH-
MonitoringOccasionOfPO is signaled in the corresponding BWP configuration.
If the UE has no 5G-S-TMSI, for instance when the UE has not yet registered onto the
network, the UE shall use as default identity UE_ID = 0 in the PF and i_s formulas above.
5G-S-TMSI is a 48 bit long bit string as defined in TS 23.501 [10]. 5G-S-TMSI shall in the
formulae above be interpreted as a binary number where the left most bit represents the most
significant bit.
(4) SI change indication and PWS notification
A modification period is used, i.e. updated SI (other than for ETWS and CMAS) is
broadcasted in the modification period following the one where SI change indication is
transmitted. The modification period boundaries are defined by SFN values for which SFN
mod m = 0, where m is the number of radio frames comprising the modification period. The
modification period is configured by system
information. The UE receives indications about SI modifications and/or PWS
notifications using Short Message transmitted with P-RNTI over DCI (see clause 6.5).
Repetitions of SI change indication may occur within preceding modification period.
UEs in RRC_IDLE or in RRC_INACTIVE shall monitor for SI change indication in its own
paging occasion every DRX cycle. UEs in RRC_CONNECTED shall monitor for SI change
indication in any paging occasion at least once per modification period if the UE is provided
with common search space on the active BWP to monitor paging, as specified in TS 38.213
[13], clause 13.
ETWS or CMAS capable UEs in RRC_IDLE or in RRC INACTIVE shall monitor for
indications about PWS notification in its own paging occasion every DRX cycle. ETWS or
CMAS capable UEs in RRC_CONNECTED shall monitor for indication about PWS
notification in any paging occasion at least once every defaultPagingCycle if the UE is
provided with common search space on the active BWP to monitor paging.
For Short Message reception in a paging occasion, the UE monitors the PDCCH monitoring
occasion(s) for paging as specified in TS 38.304 [20] and TS 38.213 [13].
If the UE receives a Short Message, the UE shall:
1>if the UE is ETWS capable or CMAS capable, the etwsAndCmasIndication bit of
Short Message is set, and the UE is provided with
searchSpaceOtherSystemInformation on the active BWP or the initial BWP:
2> immediately re-acquire the SIBI;
2>if the UE is ETWS capable and si-SchedulingInfo includes scheduling information
for SIB6:
3>acquire SIB6, as specified in sub-clause 5.2.2.3.2, immediately;
2>if the UE is ETWS capable and si-SchedulingInfo includes scheduling information
for SIB7:
3>acquire SIB7, as specified in sub-clause 5.2.2.3.2, immediately;
2>if the UE is CMAS capable and si-SchedulingInfo includes scheduling information
for SIB8:
3>acquire SIB8, as specified in sub-clause 5.2.2.3.2, immediately;
1> if the systemInfoModification bit of Short Message is set:
2>apply the SI acquisition procedure as defined in sub-clause 5.2.2.3 from the start of
the next modification period.

Hereinafter, various embodiments of the present disclosure will be described in more detail based on the above technical sprit. The contents described above may be applied to various embodiments of the present disclosure described below. For example, operations, functions, terms, etc. that are not defined in various embodiments of the present disclosure described below may be performed and explained based on the contents described above.

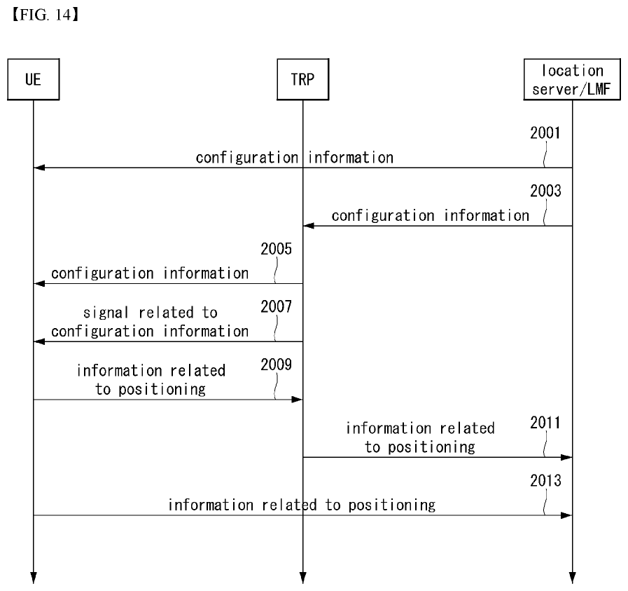

FIG. 14 is a diagram briefly illustrating a method of operating a UE, TRP, location server, and/or LMF according to various embodiments of the present disclosure.

Referring to FIG. 14, in operation 2001 according to an exemplary embodiment, the location server and/or the LMF may transmit configuration information to the UE, and the UE may receive it.

Meanwhile, in operation 2003 according to an exemplary embodiment, the location server and/or the LMF may transmit reference configuration information to a transmission and reception point (TRP), and the TRP may receive it. In operation 2005 according to an exemplary embodiment, the TRP may transmit reference configuration information to the UE, and the UE may receive it. In this case, the operation 2001 according to the exemplary embodiment may be omitted.

Conversely, the operations 2003 and 2005 according to an exemplary embodiment may be omitted. In this case, the operation 2001 according to the exemplary embodiment may be performed.

That is, the operations 2001 according to an exemplary embodiment and the operations 2003 and 2005 according to an exemplary embodiment may be optional.

In operation 2007 according to an exemplary embodiment, the TRP may transmit a signal related to configuration information to the UE, and the UE may receive it. For example, the signal related to the configuration information may be a signal for positioning of the UE.

In operation 2009 according to an exemplary embodiment, the UE may transmit a signal related to positioning to the TRP, and the TRP may receive it. In operation 2011 according to an exemplary embodiment, the TRP may transmit the signal related to positioning to the location server and/or the LMF, and the location server and/or the LMF may receive it.

Meanwhile, in operation 2013 according to an exemplary embodiment, the UE may transmit the signal related to positioning to the location server and/or the LMF, and the location server and/or the LMF may receive it. In this case, operations 2009 and 2011 according to the exemplary embodiment may be omitted.

Conversely, operation 2013 according to an exemplary embodiment may be omitted. In this case, operations 2009 and 2011 according to the exemplary embodiment may be performed.

That is, operations 2009 and 2011 according to an exemplary embodiment and operations 2013 according to an exemplary embodiment may be optional.

In an exemplary embodiment, the signal related to positioning may be obtained based on the configuration information and/or the signal related to the configuration information.

FIG. 15 is a diagram briefly illustrating a method of operating a UE, TRP, location server, and/or LMF according to various embodiments of the present disclosure.

Referring to (a) of FIG. 15, in operation 2101 according to an exemplary embodiment, the UE may receive configuration information.

In operation 2103 according to an exemplary embodiment, the UE may receive a signal related to configuration information.

In operation 2105 according to an exemplary embodiment, the UE may transmit information related to positioning.

Referring to (b) of FIG. 15, in operation 2201 according to an exemplary embodiment, the TRP may receive configuration information from the location server and/or the LMF, and may transmit it to the UE.

In operation 2203 according to an exemplary embodiment, the TRP may transmit the signal related to configuration information.

In operation 2205 according to an exemplary embodiment, the TRP may receive information related to positioning, and may transmit it to the location server and/or the LMF.

Referring to (c) of FIG. 15, in operation 2301 according to an exemplary embodiment, the location server and/or the LMF may transmit the configuration information.

In operation 2305 according to an exemplary embodiment, the location server and/or the LMF may receive the information related to positioning.

For example, the above-described configuration information may be understood as being related to reference configuration (information), reference configuration (information), reference configuration (information), one or more information transmitted/configured by the location server and/or LMF and/or TRP to the UE, etc., in the description of various embodiments of the present disclosure below, and/or it may be understood as the corresponding reference configuration (information), reference configuration (information), reference configuration (information), one or more information transmitted/configured by the location server and/or LMF and/or TRP to the UE, etc.

For example, in the description of various embodiments of the present disclosure below, the signal related to the above-mentioned positioning may be understood as a signal related to one or more of the information reported by the UE and/or it may be understood as a signal including one or more of the information reported by the corresponding UE.

For example, in the description of various embodiments of the present disclosure below, a base station, gNB, cell, etc. may be replaced with a TRP, TP, or any device that plays the same role.

For example, in the description of various embodiments of the present disclosure below, the location server may be replaced by an LMF or any device that plays the same role.

More specific operations, functions, terms, etc. in operations according to each exemplary embodiment may be performed and explained based on various embodiments of the present disclosure, which will be described later.

Hereinafter, various embodiments of the present disclosure will be described in detail. The various embodiments of the present disclosure described below may be combined in whole or in part to form further various embodiments of the present disclosure, unless they are mutually exclusive, and this can be clearly understood by those skilled in the art. Meanwhile, the operations according to each exemplary embodiment are illustrative, and one or more of the above-described operations may be omitted depending on the specific details of each embodiment.

The measurement results reported to the LMF from the UE/base station for positioning may be results measured at different time points, and may also be results measured through different methods. In terms of LMF, it is needed a method to utilize these results more efficiently in measuring the location of the UE. That is, it is required a method for LMF to efficiently utilize the results of positioning measured through different time points and/or different methods. For example, if it is guaranteed that DL or UL positioning can be done at the same time, and each measurement value is reported as LMF, in terms of LMF, each measurement result can be mutually utilized to provide more accurate measurement results. That is, if the DL positioning performed by the UE and the UL positioning performed by the base station are configured to be performed at the same time, and if the result values of DL positioning performed by the UE and UL positioning performed by the base station performed at the same time are reported in LMF, the LMF can obtain more accurate measurement results by utilizing the measurement results of positioning obtained from each UE/base station. In this respect, a measurement time window (MTW) is being considered to limit the measurement of the UE and base station to time, and in order to deliver the corresponding information to the base station and UE, definition of related signaling and detail configuration is required. That is, a measurement time window can be used to limit the measurement for positioning performed in the UE and the measurement for positioning performed in the base station in time (to ensure that the UE/base station performs measurements for positioning at the same time), and signaling and specific configuration for this need to be defined.

The present disclosure proposes a method for overall signaling and configuration of the measurement time window (MTW), which enables more accurate location measurement of the UE by transmitting the results measured in the limited time to the LMF by imposing time restrictions on positioning measurements at the base station and UE. More specifically, the present disclosure proposes a method (Method 1) of performing signaling and configuration methods for configuring a measurement time window based on absolute time (e.g. slot, radio frame), and a method (Method 2) for performing signaling and configuration methods for configuring a measurement time window based on relative time (e.g. a time point in which the UE/base station receives a request message requesting measurement for positioning from the LMF).

Method 1: Configuration Instruction Based on Absolute Time Perspective (DL Slot and/or Frame)

This method views the offset, cycle, and duration of the corresponding MTW or the corresponding duration based on system frame number (SFN) #0 and/or slot #0 as one instance, and uses repetition to instruct configuration. In other words, MTW can be configured based on (i) a time offset for a time point in which MTW starts, (ii) a cycle in which MTW is configured, and (iii) a duration of the corresponding MTW applied based on the system frame number and/or slot configured in the UE/base station. At this time, the system frame number and/or slot may be system frame and/or slot #0. In addition, the MTW configured based on the duration may be regarded as one instance, and the configuration for the number of repetitions for the instance may be additionally applied, so that the MTW may be configured in such a way that the instance is repeated. Here, the duration can be N symbols or N slots (here, N can be a positive integer), and there can be multiple MTW instances within the corresponding cycle using a repetition factor. That is, the MTW can be configured in such a way that an MTW instance with a duration configured in units of N symbols or N slots exists repeatedly at least once within one cycle in which the MTW is configured based on the repetition factor.

The gap between each MTW is also configured/instructed, or each MTW can exist as many as N symbols or N slots as the first symbol or slot of the section where the remaining duration excluding the start offset in the section within the periodicity is equally distributed by the repetition factor. That is, when at least one MTW exists, a time gap between the at least one MTW can be configured. In addition, in the entire time section within one cycle in which the MTW is configured, the remaining duration minus the start offset value that is the time length from the reference time (SFN #0 and/or slot #0) to the time point in which the first MTW is configured/exists, may be distributed/divided evenly based on the repetition factor, and each MTW may be configured/exist at a time point as many as N symbols or N slots from the first symbol or slot of each equally distributed/divided time section.

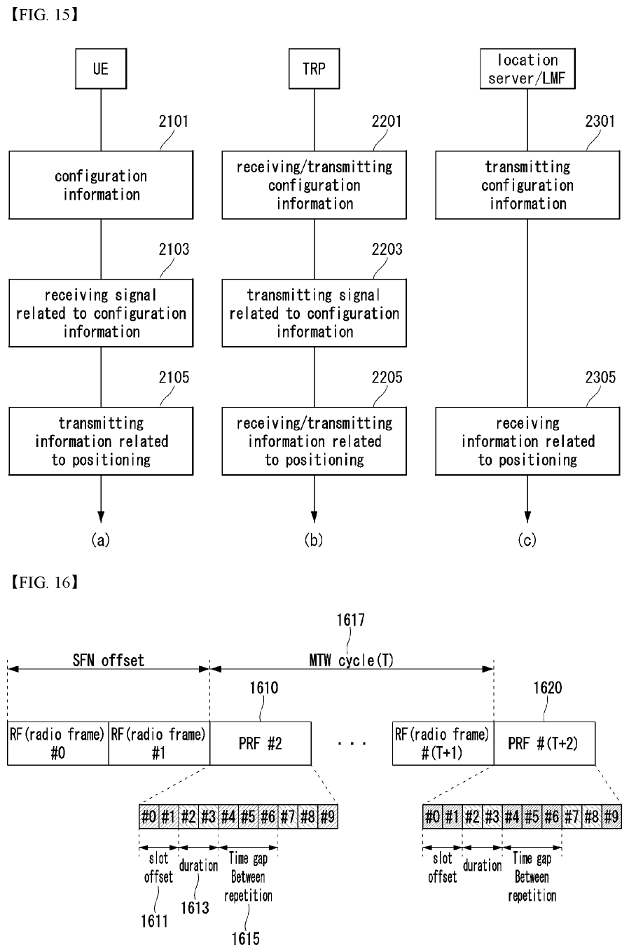

FIG. 16 is a diagram showing an example of measurement time window configuration. In FIG. 16, a radio frame in which multiple MTW exists is called a positioning radio frame (PRF) (1610 and 1620), and the corresponding PRF has a cycle (T) (16170) and starts with an offset of SFN #0. That is, the PRF can be repeatedly configured every period T, and can be configured for the first time after a time offset (SFN offset) from SFN #0. FIG. 16 illustrates a case where the time offset at which the first PRF is configured within the SFN is configured to the time length corresponding to two SFNs.

A single or multiple MTW may be configured in the PRF (1610 and 1620), and within the PRF, the MTW may have a slot offset (16110), period (1613), and repeatability. That is, one PRF (1610 and 1620) may be configured with at least one MTW (or MTW instance), and among at least one MTW (or MTW instance) configured within one PRF (1610 and 1620), the first configured/existing MTW (or MTW instance) can be configured as a specific slot offset (1610) from the first slot (slot #0) among the slots included in the PRF and as a specific duration (1613) length from subsequent slots. At this time, if multiple MTWs (or MTW instances) are configured within one PRF, a time interval 1615 may be configured between MTWs (or MTW instances) that repeatedly exist following the first configured/existing MTW (or MTW instance).

The reason why the MTW window can be configured in slot units is that the minimum unit of the time stamp transmitted when the base station and UE perform generally a measurement report is the slot unit, so it must be a unit greater than or equal to that, the method described in the present disclosure can also be applied to the subframe unit method. In other words, when the base station and the UE perform a measurement report, the minimum unit of time stamp reported with the measurement result is the slot unit, because the unit of MTW must be greater than or equal to the unit of the time stamp, it may be desirable for the configuration unit of MTW to be a slot unit. The method described in the present disclosure can be equally applied to the subframe unit method.

Additionally, the LMF may directly indicate the slot index # for MTW in bitmap form. Only cycle information for PRF can be transmitted, and the MTW existing within the corresponding PRF can be directly indicated through 10 bits. For example, if it is “1100001001”, MTW is configured in slot #0, 1 7 9. That is, the LMF (location server) can transmit to the UE/base station only information for the period in which the PRF in which at least one MTW (or MTW instance) is configured is configured, and for slots included in the PRF, information on at least one slot for which MTW is configured within the PRF may be transmitted in bitmap form. At this time, in order to reduce signaling overhead, the information in bitmap form can be commonly applied to each PRF that is repeatedly configured according to a cycle. When the information in bitmap form is commonly applied to each PRF that is repeatedly configured according to a cycle, the UE/base station can expect to receive the information in bitmap form in a radio frame and/or slot and/or symbol that exists before a certain time offset from a time point in which the first existing PRF in the system frame is started/configured, and it may not be expected to receive information in bitmap form for PRFs that are repeatedly configured/exist after the first existing PRF, and according to previously received bitmap information, MTW can be expected to be configured within PRFs that are repeatedly configured/exist after the first existing PRF.

Alternatively, for flexible MTW (or MTW instance) configuration, the information in bitmap form can be configured separately for each PRF that is repeatedly configured according to the cycle. When the information in bitmap form is configured separately for each PRF that is repeatedly configured according to a cycle, the UE/base station can expect to receive the information in bitmap form in a radio frame and/or slot and/or symbol that exists before a certain time offset from a time point in which each PRF is started/configured. The bit length of information in bitmap form may be configured to the same length as the number of slots included in the PRF.

At this time, the SFN offset can be shared with the slot offset to reduce signaling overhead, or the SFN offset and slot offset can be configured/instructed separately for flexible configuration. More specifically, when SFN offset is shared with slot offset to reduce signaling overhead, a separate offset may not be configured to indicate the start point for the MTW that is configured first within the PRF, if the value indicated by the time offset (SFN offset) is 2, the PRF that exists first within the system frame may be configured in SFN #2, the MTW (or MTW instance) that exists first within the first existing PRF may be configured for a certain duration in slot #2. In addition, if SFN offset and slot offset are configured/instructed separately for flexible configuration, a time offset (slot offset) to indicate the start point for the MTW configured first in the PRF and a time offset (SFN offset) to indicate the start point of the PRF configured first in the system frame are configured separately, if the value indicated by the time offset (slot offset) is 1, and the value indicated by the time offset (SFN offset) is 2, the first existing PRF within the system frame may be configured in SFN #2, and the MTW (or MTW instance) that exists first within the first existing PRF may be configured for a certain duration in slot #1.

Unlike what is described previously, the starting point and duration can begin with granularity in symbol units rather than slot units. This method may be configured to slot level and symbol level through a hierarchical structure, respectively. That is, the starting time point and duration of PRF/MTW (or MTW instance) for configuration for at least one PRF and at least one MTW (or MTW instance) configured within the at least one PRF may be configured in symbol units. At this time, the information composed of the symbol level may be configured in a form that has a hierarchical structure with the information composed of the slot level described above.

This method can be indicated in bitmap form to all levels, or either method can directly indicate the starting time point and duration to reduce signaling overhead. That is, the MTW slot is indicated on a slot-by-slot basis using the above indication method, and the start symbol and duration within the slot are indicated. In other words, when information consisting of slot level and information consisting of symbol level are hierarchically organized for PRF configuration and MTW (or MTW instance) configured within the PRF, one method of the information composed of slot level and the information composed of symbol level is not composed in bitmap form, but may be configured to directly instruct the starting time point and duration of PRF or MTW (or MTW instance). More specifically, the slot in which the MTW (or MTW instance) is configured within the PRF can be indicated with information in bitmap form, and within the indicated slot, the starting time point and duration of MTW (or MTW instance) can be configured based on information configured at the symbol level. At this time, the symbol level indication may be commonly configured and instructed to all MTW slots.

Additionally, the LMF may configure and instruct the multiple MTWs with the configuration structure described above. At this time, multiple configurations can be instructed in advance to support scenarios and various use cases, and (specific) configurations can be dynamically configured/instructed through NRPP or NRPPa messages.

### Method 2: Configuration of Time Window Instruction Based on Time Point of Reception or Transmission of an NRPPa/NRPP Message Such as Positioning Measurement Request

If Method 1 described above is a method of instructing configuration for periodic MTW from an absolute time perspective, this method 2 transmits only duration information from the LMF to the base station and the UE based on an NRPPa/NRPP message such as a measurement request. That is, information for the duration of MTW is included in the NRPPa/NRPP message, such as a measurement request, transmitted by the LMF to the base station and UE, and MTW is configured based on information for duration based on an NRPPa/NRPP message such as a measurement request.

The entity that requests location measurement from the UE and base station is the LMF, and since the entire location measurement process starts from the request of the LMF, the LMF can transmit a message such as a request and simultaneously transmit information for the MTW, and instruct the UE and base station the measurement within this section. That is, the request message transmitted by the LMF, which is the subject requesting location measurement to the UE and base station, to request location measurement to the UE and base station may include information for the MTW, and the UE and the base station can perform measurement for positioning based on the MTW configured based on the information for the MTW included in the request message.

The starting point of the window may be a time point in which the UE and base station begin or complete reception of a specific message from the LMF, or may be a time point in which the LMF completes transmission. That is, the starting time point of MTW can be configured to the time point in which the UE and base station start receiving a message requesting measurement for positioning from the LMF. And/or, the starting time point of MTW can be configured to the time point in which the UE and base station complete receiving a message requesting measurement for positioning from the LMF. And/or, the starting time point of MTW can be configured to the time point in which the LMF completes transmission of a message requesting measurement for positioning to the UE and the base station. At this time, due to synchronization issues, it may be desirable to start the window based on the time of message reception from each object. In other words, it may be desirable in terms of synchronization to configure the starting time point of MTW based on the time point in which the UE and base station start receiving a message requesting measurement for positioning from the LMF or the time point in which the UE and base station complete receiving a message requesting measurement for positioning from the LMF.

When transmitting the message, the LMF can also transmit duration information of N symbols, N slots, or N frames, or separately instruct the starting point of the window from the reception time point by accompanying symbol, slot, or frame offset information. That is, the message requesting measurement for positioning transmitted by the LMF to the UE and base station may include information for the duration information of the MTW expressed as the length of N symbols, N slots, or N frames. In addition, the message requesting measurement for positioning transmitted by the LMF to the UE and base station may further include information for a time point in which MTW, which is configured in units of symbol, slot, or frame, starts, and information for a time point in which the MTW starts may be based on the time point receiving a message requesting measurement for positioning from the LMF of the UE and the base station. That is, the MTW can be configured from a later time point equal to the time offset value indicated by the information for the time point in which the MTW starts from the time point the UE and base station receive a message requesting measurement for positioning from the LMF. The time point receiving a message requesting measurement for positioning from the LMF of the UE and the base station may be the time point in which the UE and the base station start receiving the message requesting measurement for positioning from the LMF, or may be the time point in which the UE and the base station complete receiving the message requesting measurement for positioning from the LMF.

In the case of Rel-16 UE, the results are measured and reported for PRS resources that exist within the measurement gap (MG). Even If a request for DL positioning measurement is transmitted to the base station and the UE, and the MG is also configured, the instructed MG may not exist or overlap within the MTW, so a definition for this case is also necessary. In other words, the Rel-16 UE performs measurements on PRS resources existing within the measurement gap (MG), and reports the results of measurement for PRS resources existing within the measurement gap (MG). At this time, a request for DL positioning measurement is transmitted from the LMF to the UE and base station, and the MG is also configured from the perspective of the UE and base station, but the configured MG may not exist within the configured MTW, or the configured MG and the configured MTW may overlap. Measurement operations for positioning of UEs and base stations for these cases need to be defined.

As above, when both MG and MTW are configured, but MG does not exist within MTW or MG and MTW overlap, for gain in terms of latency, the UE can measure within the MG and transmits the results regardless of the presence or absence of MTW, but report to the LMF 1 bit or information for representing that the UE did not measure within the MTW in the measurement report. That is, regardless of the MTW configuration, the UE performs measurements for positioning on PRS resources configured within the configured MG, and reports the results to the LMF, however, the measurement results reported to LMF may include information indicating that the measurement results are not performed by MTW, and the information may consist of a 1-bit indicator. For example, if the value of the 1-bit indicator is 0, it may indicate that the measurement result is not performed in MTW, and if the value of the 1-bit indicator is 1, it may indicate that the measurement result is performed in MTW. This can be equally applied when measuring for positioning of the base station. This is because the delay in position measurement may make position measurement more important than accuracy. In other words, the method described above can be more preferably applied in cases where the delay in position measurement may be considered more important than the accuracy of position measurement.

Considering this situation, accuracy is important in LMF, so instruction information can be transmitted through NRPPa message so that MG can exist within the MTW at the base station to request PRS measurement in the section where MTW and MG overlap. In other words, when the accuracy of position measurement may be considered more important than the delay of position measurement, the LMF can transmit information instructing that PRS measurements can be performed in the section where MTW and MG overlap to the base station through an NRPPa message. More specifically, the LMF can transmit the above information to the base station through the NRPPa message, and directly transmit the information to the UE through the NRPP message, or the base station can transmit information received through the NRPPa message to the UE through system information or RRC signaling. That is, the LMF can transmit instruction information instructing that PRS measurement is to be performed in the section where MTW and MG overlap to the base station through the NRPPa message, and directly transmit the instruction information to the UE through the NRPP message. Alternatively, the LMF can only transmit instruction information instructing that measurement of PRS be performed in the section where MTW and MG overlap to the base station through an NRPPa message, and the base station can transmit the instruction information to the UE through system information or RRC signaling.

The base station and UE can transmit the preferred MTW through LMF, if the above MTW configuration is transmitted multiple times, the base station and UE can dynamically request MTW use using MAC-CE or DCI/UCI. That is, the base station and UE can transmit information for the MTW configuration preferred by the base station and UE through the LMF, and when multiple MTW configuration are configured, the base station and UE can dynamically request MTW use using MAC-CE or DCI/UCI. At this time, by imposing an index on MTW, the UE and base station report upon the measurement report within which window is the measurement results made. That is, if at least one MTW configuration is configured, an index may be assigned to identify the MTW configuration for each of the at least one MTW configuration, and when the UE and base station perform measurements based on specific MTW configuration and report the measurement results, the UE may report the measurement result by including the index to inform the LMF that the MTW in which the measurement is performed is based on which MTW configuration among at least one MTW configuration. The UE and base station may follow the MTW configured above, but may not always expect to measure the PRS or SRS that exists within the window.

The configuration for the MTW may be independently configured and instructed to the base station and the UE, or may be commonly instructed and commonly applied to the base station and the UE. The reason for common configuration may be considering the motivation for the initial introduction of MTW, and cases in which configuration can be instructed independently may be when considering a scenario in which the MTW can be used in various ways to suit the purpose.

The LMF can instruct the base station and the UE to configure a time threshold for the MTW at the same time as instructing the MTW configuration. The time threshold can be a standard for whether to perform waiting for the measurement of DL and UL or whether to perform measurement without waiting.

The positioning request for DL/UL/DL+UL in LMF is configured separately from MTW. Since a time point in which a positioning request occurs is random, if the MTW exists within the time threshold from the time point in which the positioning request occurred or the time point in which the positioning request is received from the UE/base station, the UE performs location measurement in the corresponding MTW section and reports the measurement results, and if it does not exist within the above time threshold, the MTW is ignored and the UE and base station report the measurement results for PRS or SRS to the LMF. That is, if an MTW exists within the time section from the time point in which a positioning request occurred or the UE/base station received the positioning request to the time threshold, the UE performs measurement for positioning in the MTW that exists within the time section from the time point receiving the positioning request to the time threshold. Conversely, if the MTW does not exist within the time section from the time point in which the positioning request occurred or in which the UE/base station received the positioning request to the time threshold, the UE performs measurement for PRS (DL) or SRS (UL) regardless of whether MTW is configured and reports the measurement result to LMF for positioning.

FIG. 17 is a diagram showing examples of MTW configuration related to measurement for positioning of a UE/base station. In FIG. 17, the LMF can transmit MTW-related information to the UE through an NRPP message 1700 and to the base station (gNB) through an NRPPa message 1700, and the message 1700 can also perform an activation role. That is, the NRPP message and NRPPa message 1700 can be used to activate measurements for positioning of the UE and base station.

In FIG. 17, the MTW 1702 may start from the time point in which the corresponding message is received 1710, or may start based on the instructed time offset 1720 and 1730. At this time, the configuration information for MTWs may be duration and/or time offset and/or periodicity and/or time gap between MTWs 1720 and 1730. In other words, the MTW can start immediately from the time point in which the UE/base station receives a message (NRPP message and NRPPa message) 1700 requesting measurement for positioning from the UE/base station 1710. In addition, the MTW may start at a time point after a certain time offset from the time point in which the UE/base station receives a message (NRPP message and NRPPa message) 1700 requesting measurement for positioning from the UE/base station 1720 and 1730. In particular, when the MTW starts after a certain time offset from the time point in which the UE/base station receives a message (NRPP message and NRPPa message) 1700 requesting measurement for positioning from the UE/base station, configuration for MTW may be configured based on duration and/or time offset and/or periodicity and/or time gap between MTWs. At this time, in the case of 1720, configuration for MTW may be made based on duration and time offset. Additionally, in the case of 1720, configuration for MTW may be made based on duration, time offset, periodicity, and time gap between MTWs. In particular, a measurement performance method for positioning based on whether or not the MTW is configured within the section from the time point of generation/reception of the measurement request message to the time threshold can be applied more preferably when MTW is configured in the form of 1720 and 1730. More specifically, if the time offset for when the MTW starts at 1720 and 1730 is greater than the time threshold, the UE/base station can perform measurements for positioning for PRS or SRS regardless of MTW and report the results to LMF. Conversely, if the time offset for when MTW starts is less than or equal to the time threshold, the UE/base station can perform measurements for positioning in the MTW and report the results to the LMF. The measurement request shown in FIG. 17 is only an example and may be replaced with another message or signaling.

In addition, the UE can report capabilities related to MTW to the LMF, and the LMF can refer to and perform the request when requesting positioning measurement based on this. In other words, the UE can report information for capability of the UE for MTW to the LMF, when LMF requests the UE to measure for positioning, the LMF may perform request for measurement for the positioning to the UE by considering information for the capability of the UE for MTW received from the UE.

The above terms of MTW may be modified into other terms, but its function may be applied the same. That is, the MTW term can be expanded and expressed by various terms that can be interpreted to mean substantially the same function as the function of MTW described above. The above MG can be replaced with an additionally defined time or window so that the PRS measurement of the UE can be performed without MG after Rel-17, and MTW can be equally applied and described.

To obtain information of time difference of the different UE Rx TEGs at LMF, measuring the same DL PRS resource from a TRP with different UE Rx TEGs is agreed in the previous meeting.

```
TABLE 17
Agreement:
  Subject to UE capability, support the LMF to request a UE to optionally measure the
  same DL PRS resource of a TRP with N different UE Rx TEGs and report the
  corresponding multiple RSTD measurements.
    FFS: N=[2, 3, 4] or other values, where the maximum value of N depends on
    UE capability.
    FFS: whether the TRP can be either a “RSTD” reference TRP or a neighbor
    TRP
    FFS: details of the signalling, procedures, and UE capability
    FFS: The multiple RSTD measurements can share the same time stamp
    Note: All RSTD measurements are relative to a single reference timing
```

Before discussing the issue, there is one thing we have to solve. According to current specification, subject to UE capability, UE may report up to 4 DL RSTD measurements under the assumption that TEG is not considered. In this perspective, if we assume that UE can measure PRS with different 4 Rx TEG for the same reference timing, UE can report only one RSTD measurement per Rx TEG. Even though the multiple RSTD can be measured at each Rx TEG, UE has no choice but to report only one RSTD measurement per Rx TEG. So, if we support UE to measure PRS with multiple Rx TEGs, we should also consider increasing the current maximum number of DL RSTD measurements per TRP in the same report.

### Observation #1:

Even though the multiple RSTD can be measured at each Rx TEG, UE has no choice but to report only one RSTD measurement per Rx TEG if current regulation that UE may report up to 4 DL RSTD measurements is applied.

### Proposal #1:

RAN1 should consider increasing the current maximum number of DL RSTD measurements per TRP in the same report.

Regarding the number of UE Rx TEGs (N), we think that N=4 is appropriate by considering current rule as described above.

### Proposal #2:

Regarding the number of UE Rx TEGs (N), we think that N=4 is appropriate by considering current rule that UE may report up to 4 DL RSTD measurements per TRP.

If multiple Rx TEG is used for positioning measurement, the related location information elements can be composed as shown below.

TABLE 18

| | |
|---|---|
| nr-DL-PRS-ResourceID | NR-DL-PRS-ResourceID |

OPTIONAL,

| | |
|---|---|
| nr-DL-PRS-ResourceSetID-r16 | NR-DL-PRS-ResourceSetID |
| | OPTIONAL, |
| nr-TimeStamp | NR-TimeStamp, |
| nr-RSTD-MeasList | ::= SEQUENCE (SIZE(1..nrMaxRxREGs)) |

nr-RSTD-MeasList ::= SEQUENCE{
RxREGID

| nr-RSTD | | CHOICE { |
|---|---|---|
| | k0 | INTEGER |

(0..1970049),

| | |
|---|---|
| k1 | INTEGER |

(0..985025),

| | |
|---|---|
| k2 | INTEGER |

(0..492513),

| | |
|---|---|
| k3 | INTEGER |

(0..246257),

| | |
|---|---|
| k4 | INTEGER |

(0..123129),

| | |
|---|---|
| k5 | INTEGER |

(0..61565),

...

},

| | |
|---|---|
| nr-AdditionalPathList | NR-AdditionalPathList-r16 |
| | OPTIONAL, |
| nr-TimingQuality | NR-TimingQuality-r16, |
| nr-DL-PRS-RSRP-Result | INTEGER (0..126) |
| | OPTIONAL, |

nr-DL-TDOA-AdditionalMeasurements

NR-DL-TDOA-

| | |
|---|---|
| AdditionalMeasurements | OPTIONAL, |

...
}
}

Regarding second FFS point, we generally think that providing more information is helpful for LMF. So, the “TRP” in the above agreement can be both of them. However, considering the specification impact like as association rule, we think one of them should be the “TRP” and neighbour TRP seems appropriate since fixing the reference timing is more suitable.

### Observation #2:

If UE can measure all of PRSs from reference TRP and neighbour TRP through different Rx TEGs, it brings larger specification impact like an association rule.

### Proposal #3:

“TRP” that UE can measure PRS with different Rx TEGs needs to be a neighbour TRP.

The following agreement was made in RAN1#105-e related to the measurement time window (MTW):

```
TABLE 19
Agreement:
Consider the following options (both could be selected) until RAN1#106b-e
  Option 1: Support LMF to optionally indicate the measurement time window (MTW)
  for a UE for the measurement instances included in a measurement report.
  Option 2: Support LMF to optionally indicate the measurement time window for a
  gNB for the measurement instances included in a measurement report.
  FFS: the details of the MTW configuration.
  Any requirements can be discussed by RAN4 after decision on the options is made.
```

Since the intention of MTW is proving more relevant measurement results from time domain, we think that indicating MTW for either UE or gNB seems to be antinomy. In addition, we are sure that providing measurement results gathered from UE and gNB within specific duration is very effective way for LMF to calculate UE's location more precisely. So, RAN1 should consider all of options for DL positioning measurement.

### Proposal #6:

RAN1 should consider configuring MTW for both UE and gNB.

Regarding MTW configuration, it can be instructed from two primary point of view. The first main way is introducing positioning radio frame (PRF) in which a single or multiple MTW(s) may exist as shown in FIG. 1. The configuration of PRF can be composed of offset and cycle and then details about MTW in this PRF can be configured with start offset/duration/repetition factor (and/or including time gap). FIG. 1 shows an example of MTW configuration as described above.

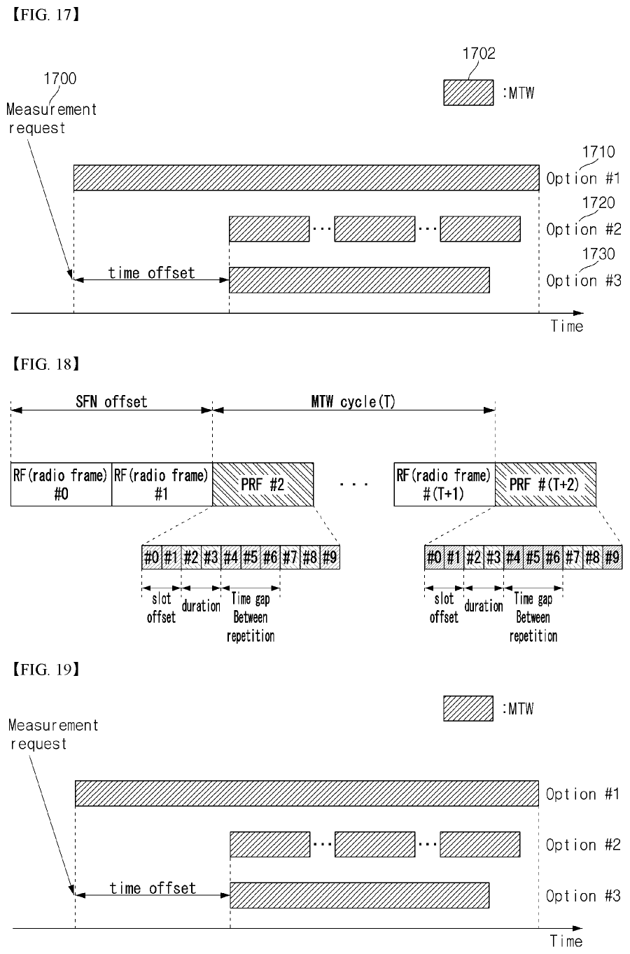

FIG. 18 is an illustrative example of MTW configuration #1.

The second primary way is that LMF provides both UE and gNB with MTW related information when LMF sends measurement request and then MTW can starts after the message dynamically. FIG. 2 shows the some examples about second way.

FIG. 19 is an illustrative example of MTW configuration #2.

The configuration of MTW can be also composed of time offset and/or duration and/or repetition (and/or including time gap).

### Proposal #7:

Regarding configuration of measurement time window (MTW), RAN1 should consider following ways to indicate/configure it.

### Type #1: Predefined Configuration

Introducing positioning radio frame (PRF) in which a single or multiple MTW(s) may exist.

Start timing offset and/or duration and/or repetition factor (and/or including time gap) for de tail configuration of MTW(s).

### Type #2: Dynamic Configuration

MTW can starts after the message from LMF such as positioning measurement request.

Start timing offset and/or duration and/or repetition factor (and/or including time gap) for de tail configuration of MTW(s).

In addition to configuration of MTW, we also need to consider the behaviour of both UE and gNB. That is, we need to decide whether UE and gNB can only fulfil the positioning measurement within MTW or not. The reason why we discuss about it is that UE and gNB have to wait until start timing of MTW if UE and gNB cannot perform positioning measurement without MTW. In this perspective, RAN1 should allow both UE and gNB to perform positioning measurement regardless of MTW.

### Observation #4:

UE and gNB have to wait until start timing of MTW if UE and gNB cannot perform positioning measurement without MTW.

### Proposal #8:

RAN1 should allow both UE and gNB to perform positioning measurement regardless of MTW.

Furthermore, considering specific use case that LMF wants to instruct both UE and gNB to perform positioning measurement within MTW, RAN1 also needs to discuss about it in detail such as related signaling, procedure and etc.

### Proposal #9:

Considering specific use case that LMF wants to instruct both UE and gNB to perform positioning measurement within MTW, RAN1 also needs to discuss about it in detail such as related signaling, procedure and etc.

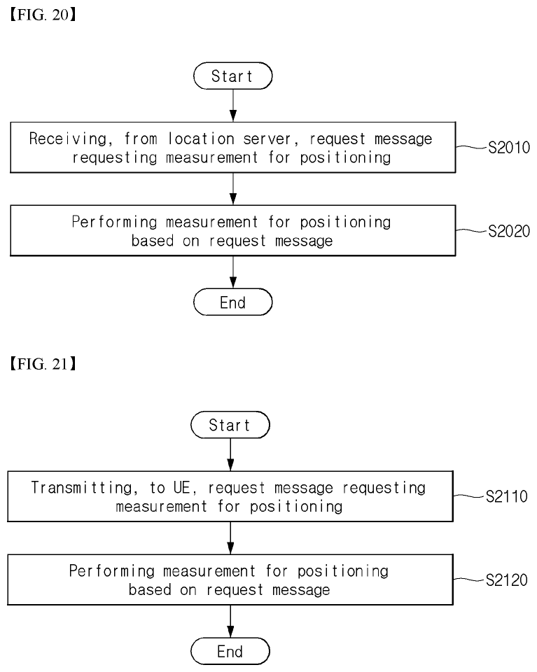

FIG. 20 is a flowchart showing an example in which a method proposed in the present disclosure is performed by a UE.

More specifically, a UE performing a method for performing positioning in a wireless communication system receives, from a location server, a request message requesting measurement for the positioning (S2010).

Here, the request message includes information for configuration of a measurement time window related to the measurement for the positioning.

Next, the UE performs the measurement for the positioning based on the request message (S2020).

Here, the measurement for the positioning is performed based on the measurement time window that is configured based on the information for configuration of the measurement time window, and the measurement time window is configured based on (i) a system frame number (SFN) and/or a slot number or (ii) a time point in which the UE receives the request message.

FIG. 21 is a flowchart showing an example in which a method proposed in the present disclosure is performed by a location server.

More specifically, the location server that performs positioning in a wireless communication system transmits, to a user equipment (UE), a request message requesting measurement for the positioning (S2110).

Here, the request message includes information for configuration of a measurement time window related to the measurement for the positioning.

Next, the location server performs the measurement for the positioning based on the request message. At this time, the measurement for the positioning is performed based on the measurement time window that is configured based on the information for configuration of the measurement time window, and the measurement time window is configured based on (i) a system frame number (SFN) and/or a slot number or (ii) a time point in which the UE receives the request message.

### Example of Communication System Applied to Present Disclosure

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

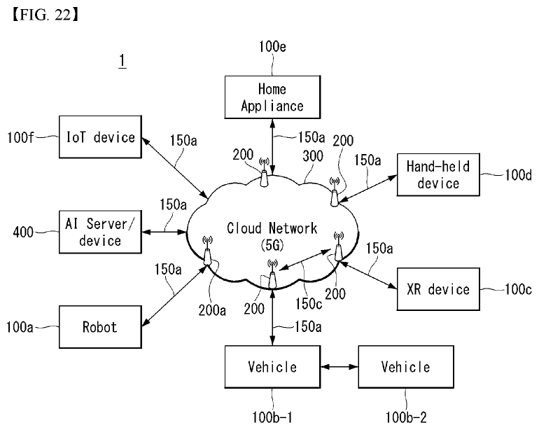

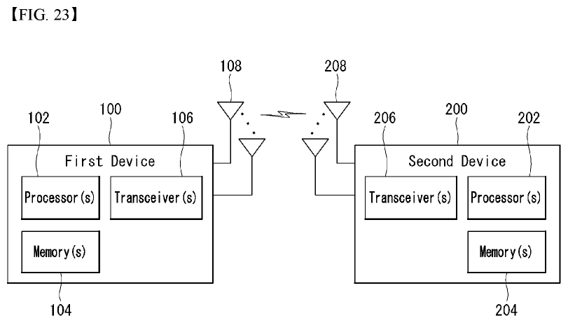

FIG. 22 illustrates a communication system 1 applied to the present disclosure.

Referring to FIG. 22, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

### Example of Wireless Device Applied to the Present Disclosure

FIG. 23 illustrates wireless devices applicable to the present disclosure.

Referring to FIG. 23, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 22.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

### Example of Signal Processing Circuit Applied to the Present Disclosure

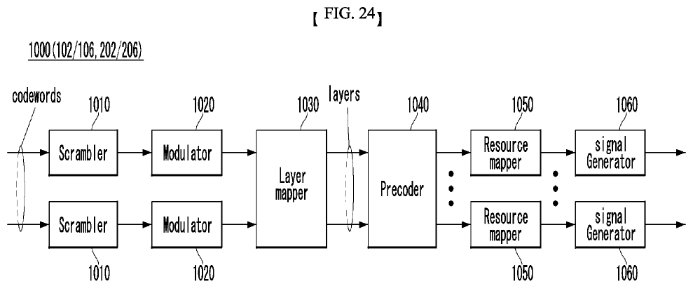

FIG. 24 illustrates a signal process circuit for a transmission signal.

Referring to FIG. 24, a signal processing circuit 1000 may include scramblers 1010, modulators 1020, a layer mapper 1030, a precoder 1040, resource mappers 1050, and signal generators 1060. An operation/function of FIG. 24 may be performed, without being limited to, the processors 102 and 202 and/or the transceivers 106 and 206 of FIG. 23. Hardware elements of FIG. 24 may be implemented by the processors 102 and 202 and/or the transceivers 106 and 206 of FIG. 23. For example, blocks 1010 to 1060 may be implemented by the processors 102 and 202 of FIG. 23. Alternatively, the blocks 1010 to 1050 may be implemented by the processors 102 and 202 of FIG. 23 and the block 1060 may be implemented by the transceivers 106 and 206 of FIG. 23.

Codewords may be converted into radio signals via the signal processing circuit 1000 of FIG. 24. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 24. For example, the wireless devices (e.g., 100 and 200 of FIG. 23) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

### Example of Application of Wireless Device Applied to the Present Disclosure

FIG. 25 illustrates another example of a wireless device applied to the present disclosure.

The wireless device may be implemented in various forms according to a use-case/service (refer to FIG. 22). Referring to FIG. 25, wireless devices 100 and 200 may correspond to the wireless devices 100 and 200 of FIG. 23 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 23. For example, the transceiver(s) 114 may include the one or more transceivers 106 and 206 and/or the one or more antennas 108 and 208 of FIG. 23. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 22), the vehicles (100b-1 and 100b-2 of FIG. 22), the XR device (100c of FIG. 22), the hand-held device (100d of FIG. 22), the home appliance (100e of FIG. 22), the IoT device (100f of FIG. 22), a digital broadcast terminal, a hologram device, a public safety device, an MTC device, a medicine device, a fintech device (or a finance device), a security device, a climate/environment device, the AI server/device (400 of FIG. 22), the BSs (200 of FIG. 22), a network node, etc. The wireless device may be used in a mobile or fixed place according to a use-example/service.

In FIG. 25, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

### Example of Hand-Held Device Applied to the Present Disclosure

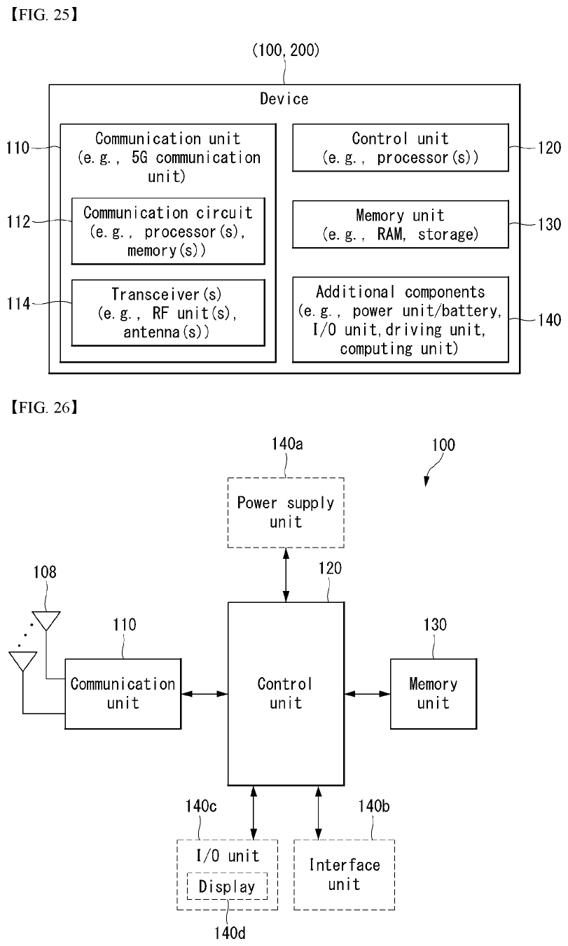

FIG. 26 illustrates a hand-held device applied to the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 26, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 25, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Here, the wireless communication technology implemented in the device (FIGS. 19 to 23) of the present disclosure may include LTE, NR, and 6G as well as Narrowband Internet of Things (NB-IoT) for low-power communication. For example, the NB-IoT technology may be an example of a LPWAN (Low Power Wide Area Network) technology, and may be implemented in standards such as LTE Cat NB1 and/or LTE Cat NB2, and is not limited to the above-described name.

Additionally or alternatively, the wireless communication technology implemented in the device (FIGS. 19 to 23) of the present disclosure may perform communication based on the LTE-M technology. For example, the LTE-M technology may be an example of LPWAN technology, and may be called by various names such as enhanced machine type communication (eMTC). For example, LTE-M technology may be implemented in at least one of various standards such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described name.

Additionally or alternatively, the wireless communication technology implemented in the device (FIGS. 19 to 23) of the present disclosure may include at least one of ZigBee, Bluetooth, and Low Power Wide Area Network (LPWAN) in consideration of low power communication, and is not limited to the above-described name. For example, the ZigBee technology may generate PAN (personal area networks) related to small/low-power digital communication based on various standards such as IEEE 802.15.4, and may be called by various names.

The embodiments of the present disclosure described hereinbelow are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by subsequent amendment after the application is filed.

The embodiments of the present disclosure may be achieved by various means, for example, hardware, firmware, software, or a combination thereof. In a hardware configuration, the methods according to the embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present disclosure may be implemented in the form of a module, a procedure, a function, etc. For example, software code may be stored in a memory unit and executed by a processor. The memories may be located at the interior or exterior of the processors and may transmit data to and receive data from the processors via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

1. A method performed by a user equipment (UE) in a wireless communication system, the method comprising:
receiving, from a location server, a request message requesting measurement for positioning,
wherein the request message includes information for configuration of a measurement time window related to the measurement for the positioning; and
performing the measurement for the positioning based on the request message,
wherein the measurement for the positioning is performed based on the measurement time window that is configured based on the information for configuration of the measurement time window, and
wherein the measurement time window is configured based on (i) a system frame number (SFN) and/or a slot number or (ii) a time point in which the UE receives the request message.

2. The method of claim 1, wherein the measurement time window is configured based on the system frame number and/or the slot number.

3. The method of claim 2, wherein the measurement time window is configured based on (i) an offset related to a time point in which the measurement time window is started from the system frame number and/or the slot number, (ii) a cycle in which the measurement time window is configured, and (iii) a duration of the measurement time window.

4. The method of claim 3, wherein one radio frame in which the measurement time window is configured includes at least one measurement time window instance.

5. The method of claim 4, wherein a number of the at least one measurement time window instance included in the one radio frame is configured based on a number of repetitions, and
wherein a time gap is configured between the at least one measurement time window instance included in the one radio frame.

6. The method of claim 5, wherein the information for configuration of the measurement time window includes (i) information for the offset related to the time point in which the measurement time window is started from the system frame number and/or the slot number, (ii) information for the cycle in which the measurement time window is configured, (iii) information for the duration of the measurement time window, (iv) information for the number of repetitions, and (v) information for the time gap configured between the at least one measurement time window instance.

7. The method of claim 6, wherein the information for the offset is applied based on both the system frame number and the slot number.

8. The method of claim 6, wherein the information for the offset includes first offset information applied based on the system frame number and second offset information applied based on the slot number.

9. The method of claim 2, wherein the measurement time window is configured based on information in bitmap form for a slot in which the measurement time window exists among at least one slot included in a radio frame in which the measurement time window is configured among all radio frames, and
wherein the information for configuration of the measurement time window includes information for a cycle in which the radio frame for which the measurement time window is configured is configured.

10. The method of claim 1, wherein the measurement time window is configured based on the time in which the UE receives the request message.

11. The method of claim 1, wherein the measurement time window starts based on (i) a time point in which the UE starts receiving the request message or (ii) a time point in which the UE ends receiving the request message and lasts for a certain period of time.

12. The method of claim 11, wherein the request message includes information for the certain period of time for which the measurement time window lasts.

13. The method of claim 12, wherein the request message further includes information for an offset from (i) a time point in which the UE starts receiving the request message or (ii) a time point in which the UE ends receiving the request message to a time point in which the measurement time window is started.

14. The method of claim 1, wherein the measurement for the positioning is performed further based on a measurement gap related to a measurement for a positioning reference signal (PRS) resource,
further comprising transmitting information for a result of the measurement for the positioning, and
wherein the information for the result of the measurement for the positioning includes information for whether the measurement for the positioning is performed within the measurement time window.

15. The method of claim 10, wherein the measurement for the positioning is performed further based on a time threshold related to whether or not to perform the measurement for the positioning within the measurement time window,
wherein based on the measurement time window being configured within the time threshold from the time in which the UE receives the request message, the measurement for the positioning is performed within the measurement time window, and
wherein based on the measurement time window being not configured within the time threshold from the time in which the UE receives the request message, the measurement for the positioning is performed in a positioning reference signal (PRS) resource regardless of the measurement time window.

16. A user equipment (UE) configured to operate in a wireless communication system, the UE comprising:
one or more transceivers;
one or more processors controlling the one or more transceivers; and
one or more memories operably connected to the one or more processors,
wherein the one or more memories store instructions for performing operations based on being executed by the one or more processors,
wherein the operations include:
receiving, from a location server, a request message requesting measurement for positioning,
wherein the request message includes information for configuration of a measurement time window related to the measurement for the positioning; and
performing the measurement for the positioning based on the request message,
wherein the measurement for the positioning is performed based on the measurement time window that is configured based on the information for configuration of the measurement time window, and
wherein the measurement time window is configured based on (i) a system frame number (SFN) and/or a slot number or (ii) a time point in which the UE receives the request message.

17-19. (canceled)

20. A location server configured to operate in a wireless communication, the location server comprising:
one or more transceivers;
one or more processors controlling the one or more transceivers; and
one or more memories operably connected to the one or more processors,
wherein the one or more memories store instructions for performing operations based on being executed by the one or more processors,
wherein the operations include:
transmitting, to a user equipment (UE), a request message requesting measurement for positioning,
wherein the request message includes information for configuration of a measurement time window related to the measurement for the positioning,
wherein the measurement for the positioning is performed, by the UE, based on the measurement time window that is configured based on the information for configuration of the measurement time window, and
wherein the measurement time window is configured based on (i) a system frame number (SFN) and/or a slot number or (ii) a time point in which the UE receives the request message.
